(19) United States
(12) Patent Application Publication
(10) Pub. No.: US 2015/0278154 A1
(43) Pub. Date: Oct. 1, 2015

(54) METHOD OF TRANSFORMING VARIABLES IN VARIATIONAL DATA ASSIMILATION MODULE USING CUBED-SPHERE GRID BASED ON SPECTRAL ELEMENT METHOD AND HARDWARE DEVICE PERFORMING THE SAME

(71) Applicant: Korea Institute of Atmospheric Prediction Systems, Seoul (KR)

(72) Inventors: Hyo-Jong SONG, Seoul (KR); Ji-Hye KWUN, Seoul (KR)

(73) Assignee: Korea Institute of Atmospheric Prediction Systems, Seoul (KR)

(21) Appl. No.: 14/243,120

(22) Filed: Apr. 2, 2014

(30) Foreign Application Priority Data
Mar. 26, 2014 (KR) 10-2014-0035015

(51) Int. Cl. G06F 17/14; G06F 17/16

(52) U.S. Cl. CPC G06F 17/14; G06F 17/16

(57) ABSTRACT

A method of transforming variables in a variational data assimilation module using a cubed-sphere grid based on a spectral element method is disclosed. First original meteorological variables are transformed into derivative meteorological variables in a background field of a numerical weather prediction model. A first error correlation between the first original meteorological variables is greater than a second error correlation between the derivative meteorological variables. The derivative meteorological variables are inversely transformed into second original meteorological variables. Values of the second original meteorological variables are adjusted based on variables in an observation field corresponding to the second original meteorological variables. The adjustment of the values of the second original meteorological variables is processed by a transpose of the inverse transformation.

### TECHNICAL FIELD

Example embodiments of the invention relate to a data assimilation method and a hardware device performing the data assimilation method. More particularly, example embodiments of the invention relate to a method of transforming variables in a variational data assimilation module using a cubed-sphere grid based on a spectral element method and a hardware device performing the method of the transforming variables in the variational data assimilation module using the cubed-sphere grid based on the spectral element method.

### DESCRIPTION OF THE RELATED ART

A numerical weather prediction (“NWP”) model is a mathematical model to compute a plurality of equations including dynamic equations and physical parameterization equations of atmosphere and ocean in order to predict a future weather condition from current or past weather conditions. The NWP model may include a dynamic core part which is important to compute the dynamic equations. The dynamic core part may describe physical quantities such as, e.g., wind, temperature, pressure, humidity, entropy, etc. as primitive equations including a plurality of partial differential equations. The dynamic core part may numerically solve a solution of the primitive equations.

The dynamic core part may perform a numerical integration of initial weather data generated based on observation data so that a weather field at a current or a future time step may be generated.

A variational data assimilation method may be used to generate the initial weather data. The variational data assimilation method may include a three-dimensional or a four-dimensional variational data assimilation method. The variational data assimilation method may be configured to search a model weather field which minimizes a cost function defined using a first difference between a background field and a model weather field generated from the NWP model and a second difference between observation data and the model weather field generated from the NWP model. The background field may be a short-term forecast field generated from the NWP model. The searched model weather field may be referred to as an analysis field. The analysis field may be used as the initial weather data of the NWP model.

The first difference between the background field and the model weather field may be defined using an error covariance of the background field (i.e., a background error covariance). The background error covariance may have degrees of freedom according to grids in a coordinates system of the NWP model. For example, if the NWP model uses a conventional longitude-latitude coordinate system having about 0.1 billion degrees of freedom, a memory space having about 0.1 billion×0.1 billion may be required to process a background error covariance of the NWP model. A weather field represented on grid points may be spectrally transformed into a weather field in a spectral space in order to reduce the vast memory space requirement.

Researches and developments have been conducted to use a cubed-sphere grid system for an NWP model so that a polar region bias of grid resolution in the conventional longitude-latitude coordinate system may be reduced and a parallelization of a numerical integration may be used.

### CONTENT OF THE INVENTION

### Technical Object of the Invention

One or more example embodiment of the invention provides a method of transforming variables in a variational data assimilation module using a cubed-sphere grid based on a spectral element method capable of generating an analysis field which may improve accuracy of weather forecast.

Also, another example embodiment of the invention provides a hardware device performing the method of the transforming variables in the variational data assimilation module using the cubed-sphere grid based on the spectral element method.

### Construction and Operation of the Invention

In an example embodiment of a method of transforming variables in a variational data assimilation module using a cubed-sphere grid based on a spectral element method, a perturbation mass variable δM defined by a first equation is converted, by using a perturbation δMbal of a balanced mass variable Mbal generated by a second equation, into a perturbation unbalanced mass variable δMu defined by a third equation. The first equation is

$$δ M = δ Φ + {RT}_{r} \frac{δ p}{\overline{p}} .$$

The second equation is −Σₖ∫_{Ω}_{ₖ}[D⁻¹D^{-T}∇_{g}Mbalᵢⱼₖ]·[∇_{g}φᵢⱼₖ]\sqrt{g}dαdβ=−Σₖ∫_{g}_{ₖ}[D^{T}[−fk×δvᵢⱼₖ+ v̅ᵢ̅ⱼ̅ₖ̅·D^{T}∇_{g}δvᵢⱼₖ+δvᵢⱼₖ·D^{T}·∇_{g} v̅ᵢ̅ⱼ̅ₖ̅]]×[∇_{g}φᵢⱼₖ]dαdβ. The third equation is δMᵤ=δM−δM_{bal}. In the first equation, δΦ is a perturbation geopotential, Tr is a temperature at a reference vertical level, R is a gas constant of an air, p̅ is an average pressure at the reference vertical level, and δp is a perturbation pressure at the reference vertical level. In the second equation, Ω is an area of an element according to the spectral element method, scalar k is an index for denoting the element in the spectral element method and is a natural number, vector k is a vertical unit vector, D is a matrix defined by horizontal unit vectors which are covariant in the cubed-sphere grid, φ is a Lagrange polynomial, subscript ijk denotes a coordinates (i, j) in the element k, \sqrt{g} is a value defined by a fourth equation, α is a first component in the cubed-sphere grid, β is a second component in the cubed-sphere grid, f is a Coriolis parameter, vector V̅ is an average of a wind vector v, vector δv is a perturbation of the wind vector v, and ∇_{g} is a gradient operator in the cubed-sphere grid. The fourth equation is \sqrt{g}≡(det(gᵢⱼ))^{1/2}. In the fourth equation, gᵢⱼ is a metric tensor defined in the cubed-sphere grid.

In an example embodiment, the wind vector v may be further converted into a stream function Ψ generated by a fifth equation. The fifth equation may be −Σₖƒ_{Ω}_{ₖ}[D^{-T}D^{-T}∇_{g}φᵢⱼₖ]·[∇_{g}φᵢⱼₖ]\sqrt{g}dαdβ=−Σₖ∫_{Ω}_{ₖ}[D^{T}vᵢⱼₖ]×[∇_{g}φᵢⱼₖ]dαdβ.

In an example embodiment, a perturbation δv_{Ψ} of a curl wind vector v_{Ψ} may be inversely converted into a horizontal wind vector component generated by a sixth equation. The sixth equation may be

$$δ {v}_{{ψ}_{ijk}} = δ \frac{1}{\sqrt{g}} {∇}_{g} \times {D}^{T} {φ}_{ijk} .$$

[symbol]

may be a perturbation stream function at the coordinates (i, j) of the element k.

In an example embodiment, the wind vector v may be converted into a velocity potential χ generated by a seventh equation. The seventh equation may be −Σₖƒ_{Ω}_{ₖ}[D⁻¹D^{-T}∇_{g}χᵢⱼₖ]·[∇_{g}φᵢⱼₖ]\sqrt{g}dαdβ=−Σₖ∫_{Ω}_{ₖ}[D⁻¹vᵢⱼₖ]×[∇_{g}φᵢⱼₖ]\sqrt{g}dαdβ.

In an example embodiment, a perturbation δv_{χ} of a divergent wind vector v_{χ} may be inversely converted into a horizontal wind vector component generated by an eighth equation. The eighth equation may be δv_{χ}_{ᵢⱼₖ}= [symbol] D^{T}∇_{g}φᵢⱼₖ. [symbol] may be a perturbation stream function at the coordinates (i, j) of the element k.

In an example embodiment of a hardware device configured to perform a method of transforming variables in a variational data assimilation module using a cubed-sphere grid based on a spectral element method, the hardware device includes a memory configured to store weather data and a computation section electrically connected to the memory. The computation section is configured to convert a perturbation mass variable δM defined by a first equation into a perturbation unbalanced mass variable δMu defined by a third equation by using a perturbation δMbal of a balanced mass variable Mbal generated by a second equation. The first equation is

$$δ M = δ Φ + {RT}_{r} \frac{δ p}{\overline{p}} .$$

The second equation is −Σₖ∫_{Ω}_{ₖ}[D⁻¹D^{-T}∇_{g}Mbalᵢⱼₖ]·[∇_{g}Φᵢⱼₖ]\sqrt{g}dαdβ=−Σₖ∫_{g}_{ₖ}[D^{T}[−fk×δvᵢⱼₖ+ v̅ᵢ̅ⱼ̅ₖ̅·D^{T}∇_{g}δvᵢⱼₖ+δvᵢⱼₖ·D^{T}·∇_{g} v̅ᵢ̅ⱼ̅ₖ̅]]×[∇_{g}Φᵢⱼₖ]dαdβ. The third equation is δMᵤ=δM−δM_{bal}. In the first equation, δΦ is a perturbation geopotential, Tr is a temperature at a reference vertical level, R is a gas constant of an air, p̅ is an average pressure at the reference vertical level, and δp is a perturbation pressure at the reference vertical level. In the second equation, Ω is an area of an element according to the spectral element method, scalar k is an index for denoting the element in the spectral element method and is a natural number, vector k is a vertical unit vector, D is a matrix defined by horizontal unit vectors which are covariant in the cubed-sphere grid, φ is a Lagrange polynomial, subscript ijk denotes a coordinates (i, j) in the element k, \sqrt{g} is a value defined by a fourth equation, α is a first component in the cubed-sphere grid, β is a second component in the cubed-sphere grid, f is a Coriolis parameter, vector v̅ is an average of a wind vector v, vector δv is a perturbation of the wind vector v, and ∇_{g} is a gradient operator in the cubed-sphere grid. The fourth equation is \sqrt{g}≡(det(gᵢⱼ))^{1/2}. In the fourth equation, gᵢⱼ is a metric tensor defined in the cubed-sphere grid.

In an example embodiment, the computation section may be further configured to convert the wind vector v into a stream function Ψ generated by a fifth equation. The fifth equation may be −Σₖ∫_{Ω}_{ₖ}[D⁻¹D^{-T}∇_{g}Φᵢⱼₖ]·[∇_{g}Φᵢⱼₖ]\sqrt{g}dαdβ=−Σₖ∫_{Ω}_{ₖ}[D^{T}vᵢⱼₖ]×[∇_{g}Φᵢⱼₖ]dαdβ.

In an example embodiment, the computation section may be further configured to inversely convert a perturbation δv_{Ψ} of a curl wind vector v_{Ψ} into a horizontal wind vector component generated by a sixth equation. The sixth equation may be

$$δ {v}_{{ψ}_{ijk}} = \frac{1}{\sqrt{g}} {∇}_{g} \times {D}^{T} {φ}_{ijk} .$$

[symbol]

may be a perturbation stream function at the coordinates (i, j) of the element k.

In an example embodiment, the computation section may be further configured to convert the wind vector v into a velocity potential χ generated by a seventh equation. The seventh equation may be −Σₖ∫_{Ω}_{ₖ}[D⁻¹D^{-T}∇_{g}χᵢⱼₖ]·[∇_{g}Φᵢⱼₖ]\sqrt{g}dαdβ=−Σₖ∫_{Ω}_{ₖ}[D⁻¹vᵢⱼₖ]×[∇_{g}Φᵢⱼₖ]\sqrt{g}dαdβ.

In an example embodiment, the computation section may be further configured to inversely convert a perturbation δv_{χ} of a divergent wind vector v_{χ} into a horizontal wind vector component generated by an eighth equation. The eighth equation may be δv_{χ}_{ᵢⱼₖ}= [symbol] D^{T}∇_{g}φᵢⱼₖ, [symbol] may be a perturbation stream function at the coordinates (i, j) of the element k.

### EFFECT OF THE INVENTION

According to one or more example embodiment of the method of transforming variables in a variational data assimilation module using a cubed-sphere grid based on a spectral element method and a hardware device performing the method of the transforming variables in the variational data assimilation module using the cubed-sphere grid based on the spectral element method, derivative weather variables having second error correlations lower than first error correlations between original weather variables may be generated so that error correlations between weather variables represented in a background field may be reduced. The derivative weather variables may be defined in the background field using the cubed-sphere grid based on the spectral element method.

Also, the derivative weather variables may be further transformed by an inverse transformation or a transpose of the inverse transformation so that a more accurate analysis field may be generated by comparing observational field to the background field. Accordingly, an accuracy of weather forecast in an NWP model may be improved.

### BRIEF EXPLANATION OF THE DRAWINGS

The above and other features and advantages of the invention will become more apparent by describing in detailed example embodiments thereof with reference to the accompanying drawings, in which:

FIG. 1 is a block diagram illustrating a hardware device performing a method of transforming variables in a variational data assimilation module using a cubed-sphere grid based on a spectral element method according to an example embodiment of the invention;

FIG. 2 is a perspective view illustrating a cubed-sphere coordinates system used in a method of transforming variables in a variational data assimilation module using a cubed-sphere grid based on a spectral element method according to an example embodiment of the invention;

FIG. 3A and FIG. 3B are perspective views illustrating representation of the cubed-sphere coordinates system in FIG. 2;

FIG. 4A and FIG. 4B are block diagrams respectively illustrating an analysis field generated from a background field and an observational field used in a method of transforming variables in a variational data assimilation module using a cubed-sphere grid based on a spectral element method according to an example embodiment of the invention;

FIG. 5 is a block diagram illustrating a transformation of a error covariance matrix used in a method of transforming variables in a variational data assimilation module using a cubed-sphere grid based on a spectral element method according to an example embodiment of the invention;

FIG. 6 is a flowchart illustrating a method of transforming variables in a variational data assimilation module using a cubed-sphere grid based on a spectral element method according to an example embodiment of the invention;

FIG. 7A is a plan view illustrating a horizontal wind distribution at a predetermined vertical level represented in a longitude-latitude coordinates system, which may be generated in a NWP model using a method of transforming variables in a variational data assimilation module using a cubed-sphere grid based on a spectral element method according to an example embodiment of the invention;

FIG. 7B is a plan view illustrating a perturbation stream function distribution and a perturbation velocity potential distribution represented in the longitude-latitude coordinates system and transformed from the horizontal wind distribution of FIG. 7A using a method of transforming variables in a variational data assimilation module using a cubed-sphere grid based on a spectral element method according to an example embodiment of the invention;

FIG. 8A is a plan view illustrating a perturbation temperature distribution at a predetermined vertical level represented in a longitude-latitude coordinates system, which may be generated in a NWP model using a method of transforming variables in a variational data assimilation module using a cubed-sphere grid based on a spectral element method according to an example embodiment of the invention;

FIG. 8B is a plan view illustrating a perturbation mass variable distribution at the same vertical level as FIG. 8A represented in the longitude-latitude coordinates system;

FIG. 8C and FIG. 8D are plan views illustrating a perturbation linear balanced mass variable distribution and a perturbation nonlinear balanced mass variable distribution, respectively, represented in the longitude-latitude coordinates system and transformed using a method of transforming variables in a variational data assimilation module using a cubed-sphere grid based on a spectral element method according to an example embodiment of the invention;

FIG. 9 is a cross-sectional view illustrating an absolute difference between a first perturbation unbalanced mass using a perturbation nonlinear balanced mass variable and a second perturbation unbalanced mass using a perturbation linear balanced mass variable with respect to a latitude and a vertical level, which may be generated using a method of transforming variables in a variational data assimilation module using a cubed-sphere grid based on a spectral element method according to an example embodiment of the invention;

FIG. 10A is a cross-sectional view illustrating an error correlation distribution between a perturbation zonal wind and a perturbation meridional wind with respect to a latitude and a vertical level in an NWP model using a method of transforming variables in a variational data assimilation module using a cubed-sphere grid based on a spectral element method according to an example embodiment of the invention;

FIG. 10B is a cross-sectional view illustrating an error correlation distribution between a perturbation stream function and a perturbation velocity potential with respect to a latitude and a vertical level in an NWP model using a method of transforming variables in a variational data assimilation module using a cubed-sphere grid based on a spectral element method according to an example embodiment of the invention;

FIG. 11A is a cross-sectional view illustrating an error correlation distribution between a perturbation mass variable and a perturbation stream function with respect to a latitude and a vertical level in an NWP model using a method of transforming variables in a variational data assimilation module using a cubed-sphere grid based on a spectral element method according to an example embodiment of the invention;

FIG. 11B is a cross-sectional view illustrating an error correlation distribution between a perturbation stream function and a perturbation unbalanced mass variable based on a linear mass equation with respect to a latitude and a vertical level in an NWP model using a method of transforming variables in a variational data assimilation module using a cubed-sphere grid based on a spectral element method according to an example embodiment of the invention;

FIG. 11C is a cross-sectional view illustrating an error correlation distribution between a perturbation stream function and a perturbation unbalanced mass variable based on a nonlinear mass equation with respect to a latitude and a vertical level in an NWP model using a method of transforming variables in a variational data assimilation module using a cubed-sphere grid based on a spectral element method according to an example embodiment of the invention;

FIG. 11D is a cross-sectional view illustrating a difference between error correlation distributions in FIG. 11B and FIG. 11C;

FIG. 12A is a plan view illustrating a perturbation surface pressure distribution represented in a longitude-latitude coordinates system in an NWP model using a method of transforming variables in a variational data assimilation module using a cubed-sphere grid based on a spectral element method according to an example embodiment of the invention;

FIG. 12B is a plan view illustrating a perturbation unbalanced surface pressure distribution based on a linear pressure equation represented in a longitude-latitude coordinates system in an NWP model using a method of transforming variables in a variational data assimilation module using a cubed-sphere grid based on a spectral element method according to an example embodiment of the invention;

FIG. 12C is a plan view illustrating a perturbation unbalanced surface pressure distribution based on a nonlinear pressure equation represented in a longitude-latitude coordinates system in an NWP model using a method of transforming variables in a variational data assimilation module using a cubed-sphere grid based on a spectral element method according to an example embodiment of the invention;

FIG. 12D is a plan view illustrating a difference between perturbation unbalanced surface pressure distributions in FIG. 12B and FIG. 12C;

FIG. 13A is a plan view illustrating an error correlation distribution between a perturbation mass variable and a perturbation stream function represented in a longitude-latitude coordinates system in an NWP model using a method of transforming variables in a variational data assimilation module using a cubed-sphere grid based on a spectral element method according to an example embodiment of the invention;

FIG. 13B is a plan view illustrating an error correlation distribution between a perturbation stream function and a perturbation unbalanced mass variable based on a linear mass equation represented in a longitude-latitude coordinates system in an NWP model using a method of transforming variables in a variational data assimilation module using a cubed-sphere grid based on a spectral element method according to an example embodiment of the invention;

FIG. 13C is a plan view illustrating an error correlation distribution between a perturbation stream function and a perturbation unbalanced mass variable based on a nonlinear mass equation represented in a longitude-latitude coordinates system in an NWP model using a method of transforming variables in a variational data assimilation module using a cubed-sphere grid based on a spectral element method according to an example embodiment of the invention; and

FIG. 13D is a plan view illustrating a difference between error correlation distributions in FIG. 13B and FIG. 13C.

### DETAILED DESCRIPTION OF THE INVENTION

Various example embodiments will be described more fully hereinafter with reference to the accompanying drawings, in which example embodiments are shown. Example embodiments may, however, be embodied in many different forms and should not be construed as limited to example embodiments set forth herein. Rather, these example embodiments are provided so that this disclosure will be thorough and complete, and will fully convey the scope of example embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third. etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the an to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the invention will be described in further detail with reference to the accompanying drawings.

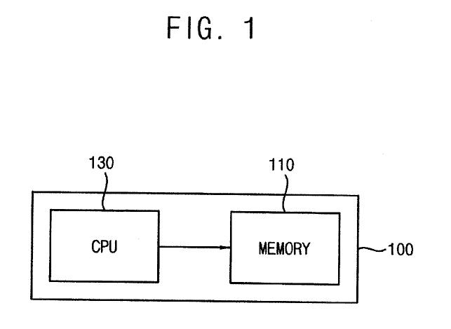

FIG. 1 is a block diagram illustrating a hardware device performing a method of transforming variables in a variational data assimilation module using a cubed-sphere grid based on a spectral element method according to an example embodiment of the invention.

Referring to FIG. 1, a hardware device 100 performing a method of transforming variables in a variational data assimilation module using a cubed-sphere grid based on a spectral element method (hereinafater, “SEM”) may include a memory 110 and a computation section 130. For example, the hardware device 100 may be a server including the memory 110 and the computation section 130. The computation section 130 may be configured to numerically compute a plurality of partial differential equations in a numerical weather prediction (hereinafter, “NWP”) model. For example, the computation section 130 may include a plurality of central processing units (CPUs). The CPUs may be configured to compute atmosphere-ocean dynamic equations and physical parameterization equations to generate a value of a physical quantity such as, e.g., temperature, wind, humidity, entropy etc. at a predetermined time step. The memory 110 may be electrically connected to the computation section 130. The memory 110 may be configured to store observation data or model data generated from the NWP model. The observation data may include, e.g., automatic weather system (AWS) data, radiosonde data, radar data, lidar data, atmosphere-ocean satellite data, or the like. The model data or the observation data may be physical quantities of an atmosphere at a location (e.g., latitude, longitude, height, etc.).

The computation section 130 may include a data assimilation section configured to process data assimilation of the model data and the observation data. In the present example embodiment, the data assimilation section may not be an independent computation unit different from the computation section 130, but the data assimilation section may be a programming module configured to compute by the plurality of CPUs in the computation section 130.

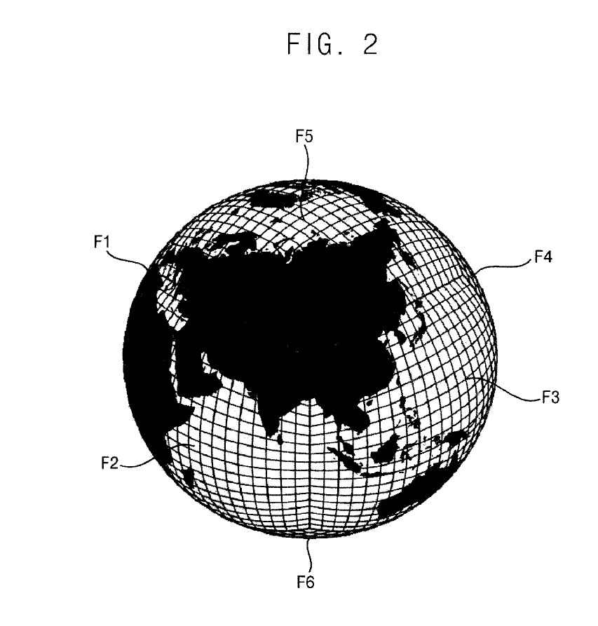

FIG. 2 is a perspective view illustrating a cubed-sphere coordinates system used in a method of transforming variables in a variational data assimilation module using a cubed-sphere grid based on a spectral element method according to an example embodiment of the invention.

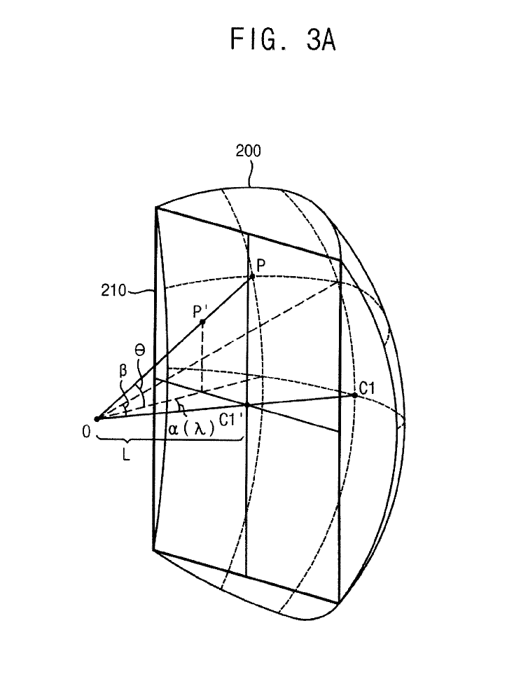

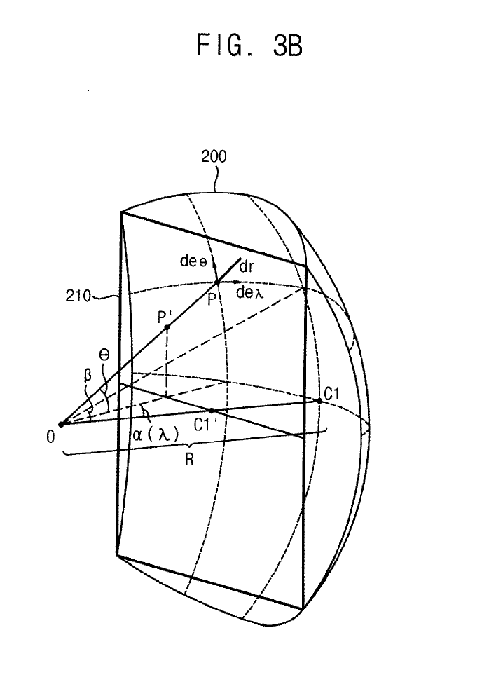

Referring to FIG. 2, a cubed-sphere coordinates system used in a method of transforming variables in a variational data assimilation module based on a SEM may include a cubed-sphere grid different from a sphere grid in a conventional longitude-latitude coordinates system. The cubed-sphere grid may be defined by six surfaces on the Earth's surface. The cubed-sphere grid may include a plurality of abscissa grid lines extending in a first direction and a plurality of ordinate grid lines extending in a second direction which crosses the first direction in each surface among the six surfaces. For example, the cubed-sphere grid may include a first surface F1 at which an intersection point of an equator and a prime meridian is centered. The cubed-sphere grid may include a second surface F2, a third surface F3 and a fourth surface F4 sequentially disposed adjacent to the first surface F1 according to a rotational direction of the Earth. The cubed-sphere grid may include a fifth surface F5 at which the North Pole NP is centered. The cubed-sphere grid may include a sixth surface F6 at which the South Pole SP is centered. The surfaces F1, F2, F3, F4, F5 and F6 may be further described in detail referring to FIG. 3A and FIG. 3B.

FIG. 3A and FIG. 3B are perspective views illustrating representation of the cubed-sphere coordinates system in FIG. 2.

Referring to FIG. 3A, a cubed-sphere coordinates system used in the present example embodiment may be an equiangular coordinates system. In the equiangular coordinate system, points in a virtual rectangular surface 210 which is spaced from a center O of the Earth by a distance L may be projected onto the Earth's surface 200. For example, a first location C1 on the Earth's surface 200 may be projected onto the rectangular surface 210 at a center C1′ of the rectangular surface 210. A second location P on the Earth's surface 200 spaced apart from the center C1′ of the rectangular surface 210 by a first angle α along an axis of abscissa and by a second angle β along an axis of ordinate may be projected onto a third point P′ on the rectangular surface 210. For example, if the first location C1 is corresponding to an intersection point of the equator and the prime meridian, then a longitude λ of the second location P may be the same as the first angle α, but a latitude θ of the second location P may be different from the second angle β.

Referring to FIG. 2 and FIG. 3A, each surface of the six surfaces F1, F2, F3, F4, F5 and F6 may be a surface divided by ±90 degrees along the axis of abscissa and the axis of ordinate on the Earth's surface 2X00. For example, the first surface F1 may correspond to a region in which the first angle α is equal to or greater than −45 degrees and lower than +45 degrees and the second angle β is equal to or greater than −45 degrees and lower than +45 degrees. Also, the second surface F2 may correspond to a region in which the first angle α is equal to or greater than −45 degrees and lower than +45 degrees and the second angle β is equal to or greater than +45 degrees and lower than +135 degrees. In a similar way, the third surface F3, the fourth surface F4, the fifth surface F5 and the sixth surface F6 may be defined.

Referring to FIG. 3B, an infinitesimal displacement dr on a sphere coordinates system (λ, θ, R) represented by a longitude λ, a latitude θ and a radius R of the Earth may be represented by the following Equation 1,

dr=R cos θdλê_{λ}+Rdθê₀. Equation 1

Here, dr denotes the infinitesimal displacement vector, e_{λ} denotes a unit vector along a longitude direction, and e_{θ} denotes a unit vector along a latitude direction. e_{λ} may be perpendicular to e_{θ} on the Earth's surface 200.

If locations on the Earth's surface 200 is represented in a cubed-sphere coordinates system (α, β, F) and F denotes a surface among the six surfaces F1 to F6, unit vectors in the cubed-sphere coordinates system may not perpendicular to each other on the Earths' surface 200. The cubed-sphere coordinates system may include a pair of first unit vectors a₁ and a₂ which are covariant and a pair of second unit vectors a¹ and a² which are contravariant.

In the cubed-sphere coordinates system, vector components (v₁, v₂) represented by the first unit vectors of a vector v on the Earth's surface 200 may be represented by the following Equation 2,

ν₁=v·a₁, ν₂=v·a₂

a₁=∂r/∂α, a₂=∂r/∂β. Equation 2

Here, v₁ denotes a component along a first direction a₁ among the pair of the first unit vectors, v₂ denotes a component along a second direction a₂ among the pair of the first unit vectors, alpha α denotes an abscissa component in the equiangular coordinates system, and beta β denotes an ordinate component in the equiangular coordinates system.

Also, the vector v may be represented by components of the pair of the contravariant second unit vectors as the following Equation 3,

V=ν¹a₁+ν²a₂, Equation 3

Here, v¹ denotes a component along a first direction a¹ among the pair of the second unit vectors, and v² denotes a component along a second direction a² among the pair of the second unit vectors.

The components of the pair of the second unit vectors which are contravariant in the equiangular coordinates system may be transformed into components perpendicular to each other in the Earth's surface 200 based on a matrix D defined by a combination of the covariant first unit vectors as the following Equation 4,

$$D = ( \begin{matrix}{a}_{1} & {a}_{2}\end{matrix} ) = R ( \begin{matrix}cos θ \partial λ / \partial α & cos θ \partial λ / \partial β \\ \partial θ / \partial α & \partial θ / \partial β\end{matrix} ) . \qquad Equation 4$$

Using the matrix D, a metric tensor g; may be defined by the following Equation 5,

gᵢⱼ=aᵢ·aⱼ=D^{T}D. Equation 5

Here, i and j may be 1 or 2, respectively.

A del operator of the metric tensor gᵢⱼ may be defined by Equation 6,

∇_{g}=(∂/∂α,∂/∂β)^{T}. Equation 6

Accordingly, a gradient operator, a divergence operator and a curl operator in the cubed-sphere grid may be defined by the following Equation 7,

$$∇ f = {D}^{T} {∇}_{g} f \\ ∇ \cdot f = \frac{1}{\sqrt{g}} {∇}_{g} \cdot [ \sqrt{g} {D}^{- 1} f ] \\ ∇ \times f = \frac{1}{\sqrt{g}} {∇}_{g} \times [ {D}^{T} f ] . \qquad Equation 7$$

For example, a Laplacian operator in the cubed-sphere grid may be derived by the following Equation 8 using the above Equation 7,

$$\begin{matrix}{∇}^{2} f = ∇ \cdot ∇ f \\ = \frac{1}{\sqrt{g}} {∇}_{g} \cdot [ \sqrt{g} {D}^{- 1} {D}^{- T} {∇}_{g} f ] .\end{matrix} \qquad Equation 8$$

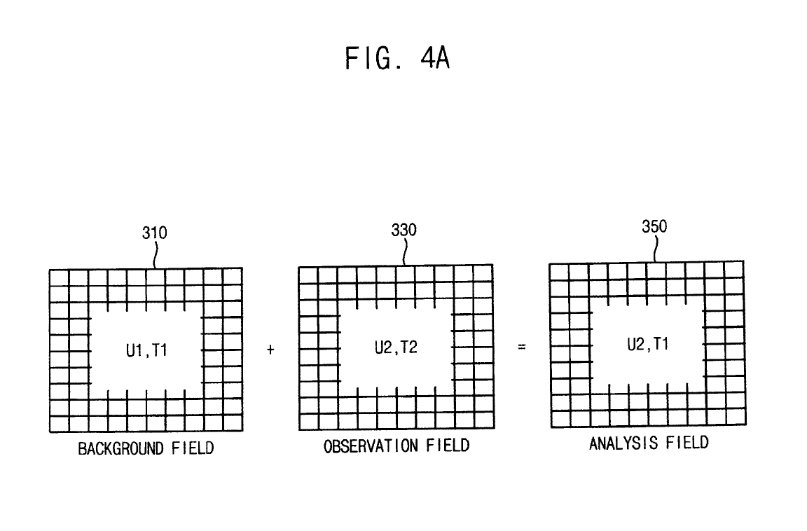

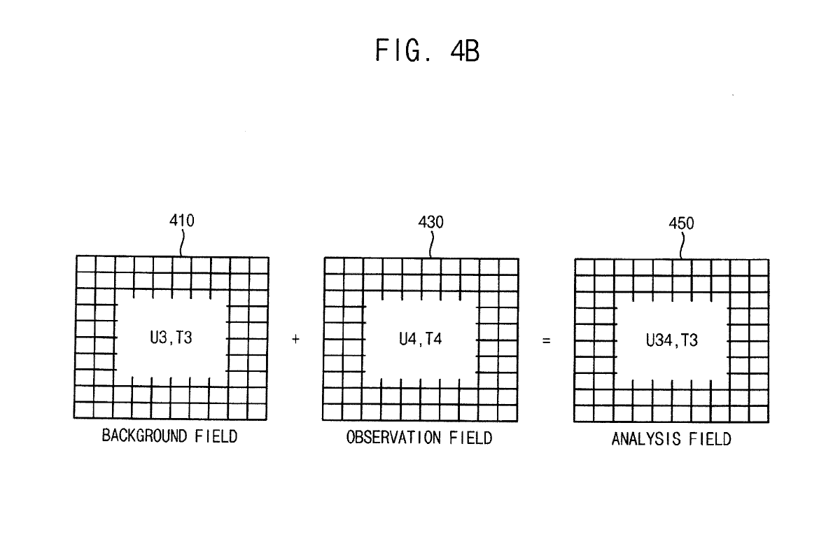

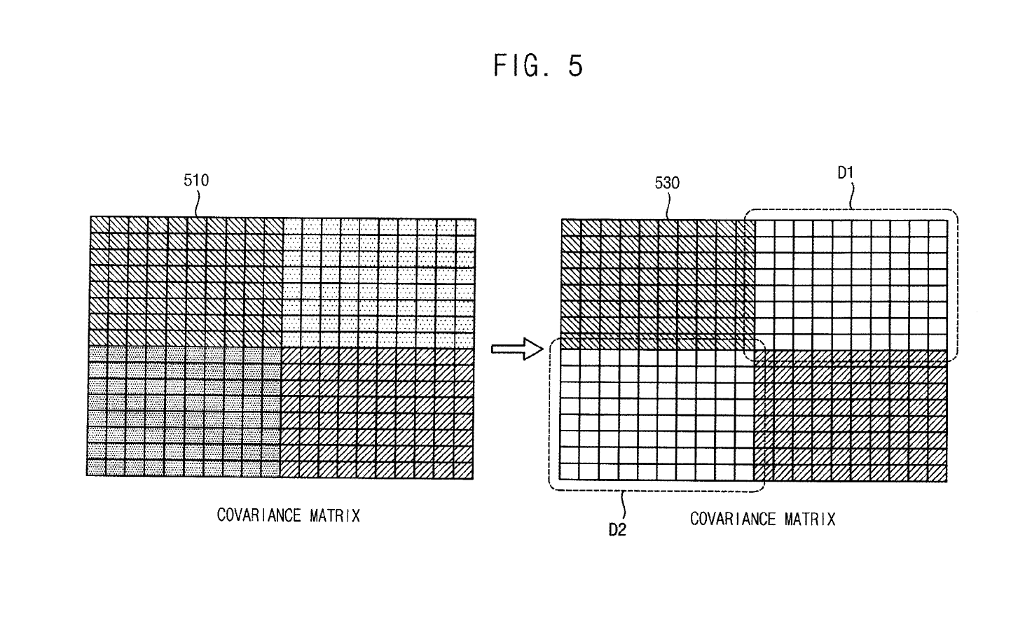

The operators in the cubed-sphere grid may be described in detail referring to FIG. 4A. FIG. 4B and FIG. 5.

FIG. 4A and FIG. 4B are block diagrams respectively illustrating an analysis field generated from a background field and an observational field used in a method of transforming variables in a variational data assimilation module using a cubed-sphere grid based on a spectral element method according to an example embodiment of the invention.

Referring to FIG. 4A, an NWP model using a method of transforming variables in a variational data assimilation module using a cubed-sphere grid based on a SEM may be configured to generate a first background field 310 in which a plurality of meteorological variables such as, e.g., a first zonal wind (u-wind) U1 and a first temperature T1 are represented. The first background field 310 may be compared to a first observation field 330 which represents a second zonal wind U2 corresponding to the first zonal wind U1 and a second temperature T2 corresponding to the first temperature T1.

The first zonal wind U1 and the first temperature T1 represented in the first background field 310 may respectively have an error variance in the first background field 310. Similarly, the second zonal wind U2 and the second temperature T2 represented in the first observation field 330 may respectively have an error variance in the first observation field 330.

For example, if an error variance of the first zonal wind U1 in the first background field 310 is greater than an error variance of the second zonal wind U2 in the first observation field 330, then the second zonal wind U2 having a lower error variance may be used in a first analysis field 350 which is input to the NWP model as an initial condition. In a similar way, if an error variance of the first temperature T1 in the first background field 310 is lower than an error variance of the second temperature T2 in the first observation field 330, then the first temperature T1 having a lower error variance my be used in the first analysis field 350. As mentioned above, the first analysis field 350 may include meteorological variables having a lower error variance by comparing the first background field 310 and the first observation field 330, thereby improving an accuracy of the initial condition of the NWP model.

However, the meteorological variables may have not only the error variances but also an error correlation between the meteorological variables in the background field and in the observation field. Therefore, it may be important to reduce error correlation between the meteorological variables in order to improve the accuracy of the initial condition of the NWP model.

Referring to FIG. 4B, a plurality of meteorological variables such as, e.g., a third zonal wind U3 and a third temperature T3 may be represented in a second background field 410 in the NWP model. Similarly, a fourth zonal wind U4 corresponding to the third zonal wind U3 and a fourth temperature T4 corresponding to the third temperature T3 may be represented in a second observation field 430 in the NWP model. If a second analysis field 450 is generated by comparing the second background field 410 and the second observation field 430 as the initial condition of the NWP model, correlations between the zonal winds and the temperatures may affect values of the variables in the second analysis field 450.

For example, although an error variance of the third zonal wind U3 in the second background field 410 is greater than an error variance of the fourth zonal wind U4 in the second observation field 430 and an error variance of the third temperature T3 in the second background field 410 is lower than an error variance of the fourth temperature T4 in the second observation field 430, values of a fifth zonal wind U34 used in the second analysis field 450 may be affected by both of the third zonal wind 1U3 and the fourth zonal wind U4 when a variable correlation between the third zonal wind U3 and the third temperature T3 is high in the second background field 410.

Therefore, it may be required to reduce correlations between meteorological variables in a background field, thereby improving accuracy of initial conditions of an analysis field which is generated based on the background field.

FIG. 5 is a block diagram illustrating a transformation of a error covariance matrix used in a method of transforming variables in a variational data assimilation module using a cubed-sphere grid based on a spectral element method according to an example embodiment of the invention.

Referring to FIG. 5, a error covariance matrix between meteorological variables used in a background field in an NWP model may have a desired dimension. For example, if a number of grid points of the NWP model is 0.1 billion at a vertical level, a dimension of an original covariance matrix 510 between two variables at the vertical level may be 0.1 billion×0.1 billion. As the original covariance matrix 510 has a vast dimension, the original covariance matrix 510 may be difficult to numerically compute in a data assimilation system in an operational NWP model.

However, if the original covariance matrix 510 is transformed into a block diagonal matrix 530 in which other blocks D1 and D2 become all zero (or nearly zero), a time and memory space required to compute the block diagonal matrix 530 may be greatly reduced.

As mentioned above, original meteorological variables in an operational NWP model may be transformed into derivative meteorological variables for a numerical computation, thereby transforming an original covariance matrix which represents error correlations between the original meteorological variables into a block diagonal matrix which represents error correlations between the derivative meteorological variables lower than the error correlations between the original meteorological variables.

The derivative meteorological variables used in the block diagonal matrix may be required to be inversely transformed into the original meteorological variables to compare them with an observation field data. Accordingly, an inverse process from the derivative meteorological variables to the original meteorological variables may be additionally required.

Also, values of the inversely transformed original meteorological variables may be further required to be adjusted by comparing values of corresponding variables in the observation field in order to improve an accuracy of an initial condition. In this case, a transpose of the inverse transformation may be further required.

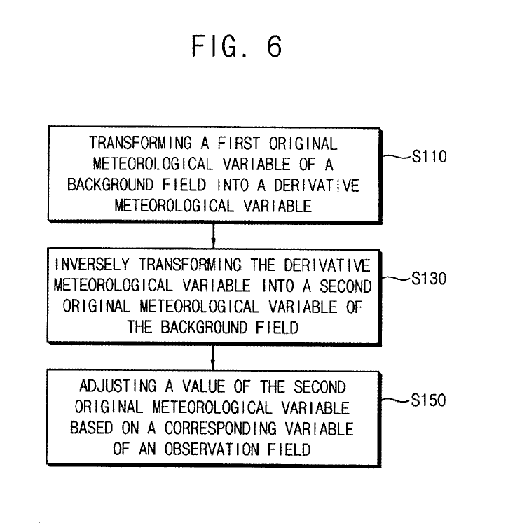

FIG. 6 is a flowchart illustrating a method of transforming variables in a variational data assimilation module using a cubed-sphere grid based on a spectral element method according to an example embodiment of the invention.

Referring to FIG. 6, in a method of transforming variables in a variational data assimilation module using a cubed-sphere grid based on a SEM according to the present example embodiment, first original meteorological variables may be transformed into derivative meteorological variables in a background field in a step S110. The derivative meteorological variables may be further inversely transformed into second original variables in the background field in a step S130. Values of the second original meteorological variables may be further adjusted based on corresponding variables in an observation field in a step S150.

Hereinafter, the transformation of the first original meteorological variables into the derivative meteorological variables in the step S110, the inverse transformation of the derivative meteorological variables into the second original meteorological variables in the step S130 and the adjustment of the values of the second original meteorological variables in the step S150 are described in detail with a discretization process in a cubed-sphere grid based on a SEM. In the adjustment of the values of the second original meteorological variables in the step S150, meteorological variables may be processed according to a transpose operator of the inverse transformation.

### Transformation of Original Weather Variables into Derivative Weather Variables

In the present example embodiment, original weather variables may include meteorological variables such as, e.g., a zonal wind (u-wind), a meridional wind (v-wind), a temperature, a humidity, a geopotential, a surface pressure, a mass variable, or the like.

In the present example embodiment, derivative weather variables may include meteorological variables such as a stream function, a velocity potential, a balanced mass variable, an unbalanced mass variable, a balanced surface pressure, an unbalanced surface pressure, or the like.

Perturbations of the zonal wind (u-wind) and the meridional wind (v-wind) may be transformed into perturbations of the stream function and the velocity potential based on a Helmholtz decomposition equation such as the following Equation 9.

∇²δΨ=k·∇×δv

∇²δχ=∇·δv Equation 9

Here, a vector v denotes a wind vector, a psi Ψ denotes a stream function, a chi χ denotes a velocity potential, a delta δ denotes a perturbation, and a vector k denotes a vertical unit vector.

Referring to FIG. 3B again, an integration of a physical field (or a physical parameter) f represented in a longitude-latitude coordinates system on the Earth's surface 200 may be defined by an integration in a cubed-sphere grid based on a SEM by using the metric tensor gᵢⱼ in Equation 5 as the following Equation 10,

∫_{-π/2}^{π/2}∫₀^{2π}f(λ,θ)R² cos θdλdθ=Σₖ∫_{Ω}_{^{k}}f(α,β)\sqrt{g}dαdβ

\sqrt{g}≡(det(gᵢⱼ))^{1/2}=|α₁×α₂|. Equation 10

Here, Ω denotes an area of an element in the SEM, and a scalar k denotes an index for indicating the element. The scalar k may be a natural number or an integer.

A Lagrange polynomial may be used to discretize the integration of Equation 10 based on the SEM.

For example, if the Earth's surface 200 is divided into six surfaces F1, F2, F3, F4, F5 and F6 and each surface of the six surfaces is divided into a plurality of elements which include Gauss-Legendre-Lobatto grid points (hereinafter, “GLL points”), the physical field f in a cubed-sphere grid may be represented by the following Equation 11 using a Lagrange polynomial Φ corresponding to the GLL points,

f(α,β)≈Σⱼ₌₀^{N}Σᵢ₌₀^{N}\hat{f}ᵢⱼφᵢ(α,β)φⱼ(α,β). Equation 11

Here, i denotes an index of a GLL point along an axis of abscissa in an element, j denotes an index of the GLL point along an axis of ordinate in the element, and N denotes a number of GLL points in a single side of the element (i.e., each of the elements may include N+1 GLL points in total in a side). Also, a cap marked ̂fᵢⱼ denotes a coefficient of a Lagrange polynomial in each of the elements.

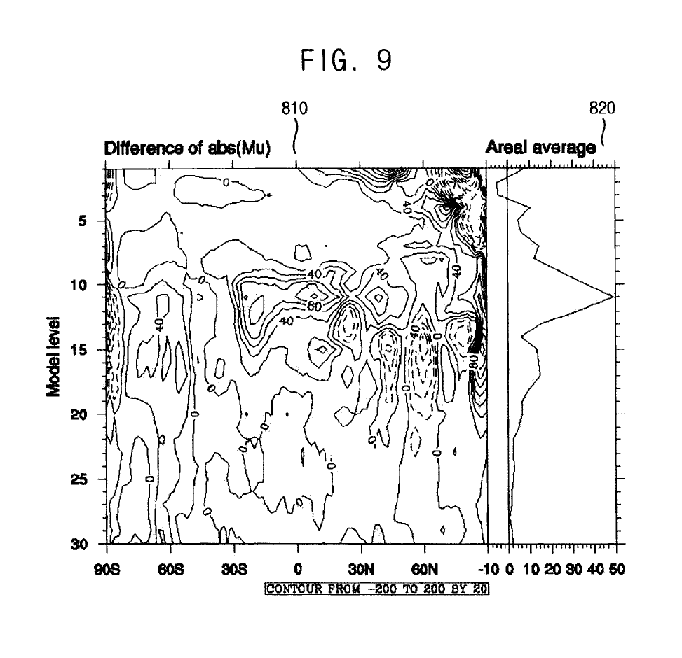

Accordingly, by arranging the Helmholtz decomposition equation in FIG. 9 based on the above Equation 6, Equation 7. Equation 8, Equation 10 and Equation 11, a wind vector v may be transformed into a stream function ψ and a velocity potential χ in a cubed-sphere grid as the following Equation 12,

−Σₖ∫_{Ω}_{ₖ}[D⁻¹D^{-T}∇_{g}φᵢⱼₖ]·[∇_{g}φᵢⱼₖ]\sqrt{g}dαdβ=−Σₖ∫_{g}_{ₖ}[D^{T}vᵢⱼₖ]×[∇_{g}φᵢⱼₖ]dαdβ

−Σₖ∫_{Ω}_{ₖ}[D⁻¹D^{-T}∇_{g}χᵢⱼₖ]·[∇_{g}φᵢⱼₖ]\sqrt{g}dαdβ=−Σₖ∫_{g}_{ₖ}[D⁻¹vᵢⱼₖ]×[∇_{g}φᵢⱼₖ]dαdβ. Equation 12

Here, a subscript ijk denotes a GLL point (i, j) in a k-th element.

If original weather variables are transformed into derivative weather variables based on a balance of the atmosphere of the Earth, a linear/nonlinear balance equation and a hydrostatic equation may be used.

For example, a linear or a nonlinear equation between wind and mass variable may be used as the following. If an NWP model uses a hybrid vertical coordinates as a vertical coordinates, a pressure p and a perturbation pressure δp of the NWP model may be represented by the following Equation 13,

p̅(̅η̅)̅=A(η)p₀+B(η) p̅ₛ̅

δp(η)=B(η)δpₛ Equation 13

Here, eta η denotes a hybrid sigma (σ) vertical level, p0 denotes a reference surface pressure, ps denotes a surface pressure, and A and B denote coefficients in the hybrid sigma vertical level. A bar mark (-) above a character denotes an average and a delta (δ) before the character denotes a perturbation.

A perturbation SM of a mass variable M may be defined by the following Equation 14 using a linearized hydrostatic equation,

$$δ M = δ Φ + {RT}_{r} \frac{δ p}{\overline{p}} . \qquad Equation 14$$

Here, phi Φ denotes a geopotential, Tr denotes a temperature at a reference vertical level, and R denotes a gas constant of an air.

In the above Equation 14, a perturbation geopotential δΦ may be represented by the following Equation 15,

$$δ Φ = {\int }_{η}^{1} R δ {T}_{v} \frac{\partial ln \overline{p}}{\partial η} + R \overline{{T}_{v}} \frac{\partial }{\partial η} \frac{\partial p}{\overline{p}} d η . \qquad Equation 15$$

Here, Tv denotes a virtual temperature defined by the following Equation 16. That is, an average virtual temperature and a perturbation virtual temperature according to a hybrid vertical level may be represented by the following Equation 16,

T̅ᵥ̅= T̅(1+(Rᵥ/R_{d}−1) q̅)

δTᵥ=δT(1+(Rᵥ/R_{d}−1) q̅)+ T̅(Rᵥ/R_{d}−1)δq Equation 16

Here, Rd denotes a gas constant of a dray air, Rv denotes a gas constant of a moist air, and q denotes a specific humidity.

A nonlinear balance equation between wind and mass variable may be represented by the following Equation 17,

∇²δM_{bal}=−∇·(fk×δv+ v̅·∇δv+δv·∇ v̅). Equation 17

Here, Mbal denotes a balanced mass variable, a vector v denotes a wind vector. In the above Equation 17, a scalar f denotes a Coriolis parameter, a vector k denotes a vertical unit vector, and a delta δ denotes a perturbation.

Underlined terms in a right hand side of the above Equation 17 are associated with rotation and advection of the wind. By removing the underline terms, a linear balance equation between wind and mass variable may be represented by the following Equation 18,

∇²δM_{bal}=−∇·(fk×δv) Equation 18

Accordingly, by using the above Equation 14 and one of the Equation 17 and the Equation 18, an unbalanced mass variable Mu may be generated as the following Equation 19. The unbalanced mass variable Mu may be a mass variable of which an error correlation with other weather variables such as e.g., geopotential, pressure, temperature, wind, etc. is reduced, which is different from the balanced mass variable Mbal,

δMᵤ=δM−δM_{bal} Equation 19

Here, delta δ denotes a perturbation.

A discretization process for a cubed-sphere grid based on a SEM may be required to obtain the unbalanced mass variable Mu having a lower error correlation with other weather variables. For example, a discretized nonlinear balance equation as the following Equation 20 may be obtained by arranging the Equation 17 based on the above Equation 6, Equation 7, Equation 8, Equation 10 and Equation 11,

−Σₖ∫_{Ω}_{ₖ}[D⁻¹D^{-T}∇_{g}Mbalᵢⱼₖ]·[∇_{g}φᵢⱼₖ]\sqrt{g}dαdβ=−Σₖ∫_{Ω}_{ₖ}[D^{T}[−fk×δvᵢⱼₖ+ v̅ᵢ̅ⱼ̅ₖ̅·D^{T}∇_{g}δvᵢⱼₖ+δvᵢⱼₖ·D^{T}·∇_{g} v̅ᵢ̅ⱼ̅ₖ̅]]×[∇_{g}φᵢⱼₖ]dαdβ Equation 20

Here, a subscript ijk denotes a GLL point (i, j) in a k-th element. If rotational and advection components (i.e., a middle term and a rightmost term within an integral) in the right hand side of the Equation 20 are removed, then a discretized linear balance equation may be obtained.

In a similar way to the above Equation 17, a balanced surface pressure ps_{bal} may be represented by the following Equation 21 with respect to a surface which is a lowermost vertical level of the NWP model,

$${∇}^{2} δ {p}_{{s}_{bal}} = - \frac{\overline{p}}{{RT}_{r}} ∇ \cdot ( fk \times δ {v}_{s} + \underline{\overline{{v}_{s}} \cdot ∇ δ {v}_{s} + d {v}_{s} \cdot ∇ \overline{{v}_{s}} )} . \qquad Equation 21$$

Here, R denotes a gas constant of an air, Tr denotes a temperature at a reference vertical level, p denotes a pressure, vector v, denotes a surface wind, and a scalar f denotes a Coriolis parameter. In the Equation 21, underlined terms in the right hand side is associated with rotation and advection of wind. If the underlined terms are removed, a linear balance equation may be generated. A linear balance equation of the surface pressure is omitted for ease of description.

An unbalanced surface pressure ps may be obtained as the following Equation 22 under a suggestion that the surface pressure ps includes a balanced component and an unbalanced component. The unbalanced surface pressure psᵤ may be a surface pressure of which an error correlation with other weather variables such as, e.g., temperature, wind, etc. is reduced, which is different from the linear surface pressure ps_{bal}.

δpₛ_{ᵤ}=pₛ−δpₛ_{_{bal}}. Equation 22

Here, delta δ denotes a perturbation.

A discretization process for a cubed-sphere grid based on a SEM may be required to obtain the unbalanced surface pressure ps, having a lower error correlation with other weather variables. For example, a discretized nonlinear balance equation as the following Equation 23 may be obtained by arranging the Equation 21 based on the above Equation 6, Equation 7, Equation 8, Equation 10 and Equation 11,

$$- {\sum }_{k} {\int }_{{Ω}_{k}} [ {D}^{- 1} {D}^{- T} {∇}_{g} {Psbal}_{ijk} ] \cdot [ {∇}_{s} {φ}_{ijk} ] \sqrt{g} d α d β = - \frac{\overline{p}}{{RT}_{r}} {\sum }_{k} {\int }_{{Ω}_{k}} [ {D}^{T} [ - fk \times δ {v}_{sijk} + \overline{{v}_{sijk}} \cdot {D}^{T} {∇}_{g} δ {v}_{sijk} + δ {v}_{sijk} \cdot {D}^{T} \cdot {∇}_{g} \overline{{v}_{sijk}} ] ] \times [ {∇}_{g} {φ}_{ijk} ] d α d β . \qquad Equation 23$$

Here, a subscript ijk denotes a GLL point (i, j) in a k-th element. If rotational and advection components (i.e., a middle term and a rightmost term within an integral) in the right hand side of the Equation 23 are removed, then a discretized linear balance equation may be obtained.

### Inverse Transformation of Derivative Weather Variables into Original Weather Variables

In the present example embodiment, an inverse Laplacian operation used in an inverse transformation of derivative weather variables into original weather variables may be used with a parallelized conjugate gradient method which is well-known in the art to which the present invention relates.

For example, if the derivative weather variables includes meteorological variables such as, e.g., stream function, velocity potential, etc., then a curl wind vector v_{Ψ} and a divergent wind vector v_{χ} may be obtained by the following Equation 24 based on the Helmholtz decomposition equation,

δv_{Ψ}=k×∇δΨ

δv_{χ}=∇δΨ Equation 24

Here, Ψ denotes stream function, vector k denotes a vertical unit vector, and delta δ denotes a perturbation.

Accordingly, a horizontal wind vector v may be restored using the Equation 24 as the following Equation 25,

δv=δv_{Ψ}+δv_{χ}. Equation 25

Therefore, a discretization process of restoring the horizontal wind vector v from the stream function Ψ in a cubed-sphere grid based on a SEM may be represented by the following Equation 26 by inversely arranging the above Equation 6, Equation 7, Equation 8, Equation 10 and Equation 11,

Equation 26

$$δ {v}_{ψ} ( i , j , k ) = \frac{1}{\sqrt{g}} {∇}_{g} \times {D}^{T} {φ}_{ijk}$$

$$δ {v}_{χ} ( i , j , k ) = {D}^{T} {∇}_{g} {φ}_{ijk} .$$

Here, subscript ijk denotes a GLL point (i, j) in a k-th element, phi Φ denotes a Lagrange polynomial, and a cap mark ̂ above a character denotes a coefficient.

In order to restore a perturbation of pressure p, the above Equation 21 to the Equation 24 with respect to the balanced surface pressure ps_{bal} and the unbalanced surface pressure psᵤ may be inversely computed.

In a similar way, the above Equation 17 to the Equation 20 with respect to the derivative variables such as the balanced mass variable Mbal and the unbalanced mass variable Mu may be inversely computed to restore perturbations of original variables such as mass variable M and geopotential Φ.

Similarly, an inverse transformation of a linearized hydrostatic equation such as the following Equation 27 may be solved to restore perturbation of temperature T,

$$δ {T}_{v} = - \frac{1}{R} ( \frac{\partial δ Φ}{\partial η} / \frac{\partial ln \overline{p}}{\partial η} - \frac{\partial \overline{Φ}}{\partial η} / {( \frac{\partial δ p / \overline{p}}{\partial η} )}^{2} ) \\ δ T = \frac{δ {T}_{v}}{1 + ( {R}_{v} / {R}_{d} - 1 ) \overline{q}} - \overline{{T}_{v}} \frac{{R}_{v} / {R}_{d} - 1}{{( 1 + ( {R}_{v} / {R}_{d} - 1 ) \overline{q} )}^{2}} δ q . \qquad Equation 27$$

Here, Tv denotes a virtual temperature. R denotes a gas constant of an air, eta η denotes a hybrid sigma vertical level, Rd denotes a gas constant of a dry air, Rv denotes a gas constant of a moist air, q denotes a specific humidity, p denotes a pressure, and phi Φ denotes a geopotential. A bar mark (-) above a character denotes an average value, and a delta fi before a character denotes a perturbation.

Transpose Operation of an Inverse Transformation

In the present example embodiment, values of original weather variables restored by the inverse transformation may be adjusted compared to values of corresponding weather variables in an observation field. The values of the original weather variables may be adjusted by performing an operation corresponding to a transpose matrix of the inverse transformation.

For example, if the inverse transformation process from derivative variables into original weather variables is written in a programming language such as, e.g., Fortran 90 language, then respective code line may be transposed inversely by constructing a small line-by-line matrix. For example, the inverse transformation restoring the horizontal wind vector from the stream function and the velocity potential in the above Equation 24 may be processed by the following pseudo-code 1,

Pseudo-code 1

DO k = 1, nlev

utmp = 0.D0
DO ie = nets, nete

utmp = Gradient_Sphere(psi(:,:,k,ie),deriv(hybrid%ithr), &

elem(ie)%dinv)

urot(:,:,k,1,ie) = −utmp(:,:,2)
urot(:,:,k,2,ie) = utmp(:,:,1)

END DO

END DO

Here, code lines written in a DO repeat library with respect to a hybrid vertical level k may be inversely transposed to obtain the following pseudo-code 2,

Pseudo-code 2

DO k = nlev, 1, −1

DO ie = nete, nets, −1

ad_utmp(:,:,1) = ad_utmp(:,:,1) + ad_urot(:,:,k,2,ie)
ad_urot(:,:,k,2,ie) = 0.D0
ad_utmp(:,:,2) = ad_utmp(:,:,2) − ad_urot(:,:,k,1,ie)
ad_urot(:,:,k,1,ie) = 0.D0
CALL AdjGradientSphere(ad_utmp, deriv(hybrid%ithr), &

elem(ie)%Dinv, ad_psi(:,:,k,ie))

END DO
ad_utmp = 0.D0

END DO

As mentioned above, an adjustment of original weather variables restored from derivative weather variables may be performed by inversely transposing the inverse transformation operation.

Therefore, original weather variables having a relatively large error correlation between the variables may be transformed into derivative weather variables having a relatively small error correlation between the variables, and original weather variables may be restored from the derivative weather variables, and then the original weather variables may be adjusted by comparing an observation field. The above processes may be iterated, thereby improving an accuracy of analysis field as an initial condition.

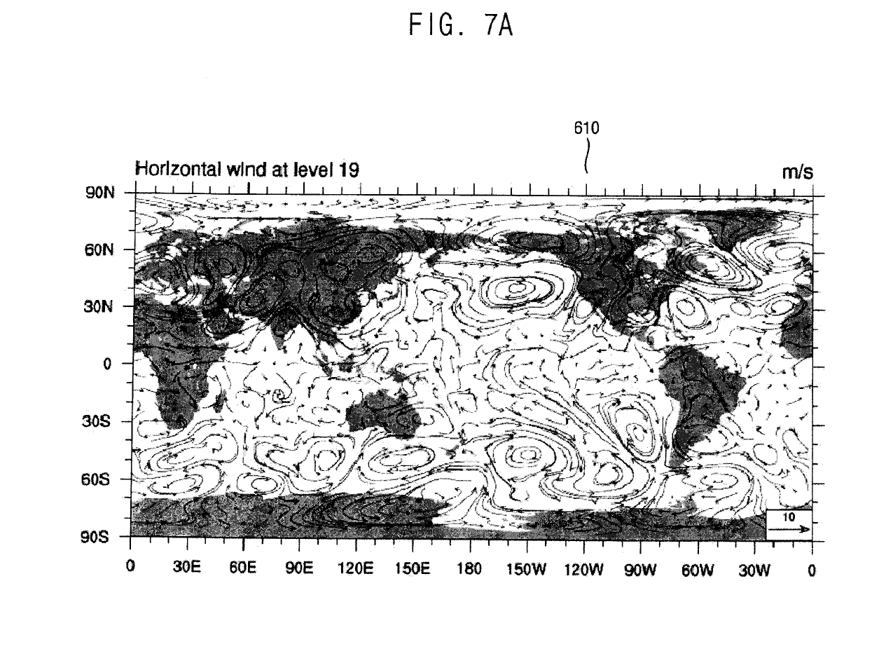

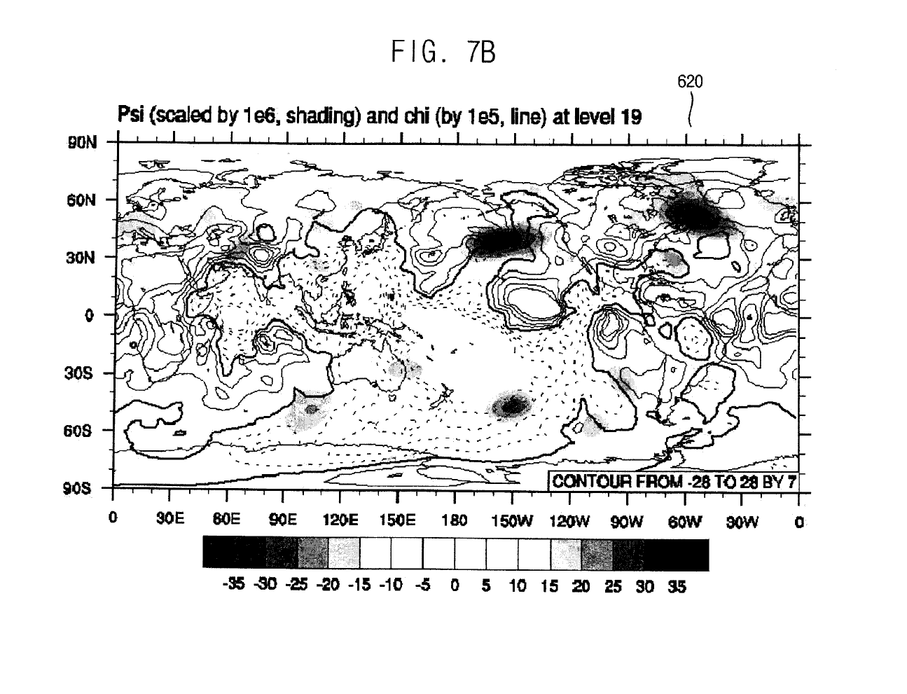

FIG. 7A is a plan view illustrating a horizontal wind distribution at a predetermined vertical level represented in a longitude-latitude coordinates system, which may be generated in a NWP model using a method of transforming variables in a variational data assimilation module using a cubed-sphere grid based on a spectral element method according to an example embodiment of the invention.

Referring to FIG. 7A, an NWP model using a method of transforming variables in a variational data assimilation module using a cubed-sphere grid based on a SEM according to the present example embodiment may be configured to represent a horizontal wind distribution 610 at, e.g., a vertical level 19 corresponding to about 500 hPa height in a time step. In the horizontal wind distribution 610, a unit of wind is meters per second. For example, anticyclonic circulation wind may be dominant in a North Pacific region in the horizontal wind distribution 610. For example, divergent wind may be dominant in an East Pacific region above the Equator in the horizontal wind distribution 610.

FIG. 7B is a plan view illustrating a perturbation stream function distribution and a perturbation velocity potential distribution represented in the longitude-latitude coordinates system and transformed from the horizontal wind distribution of FIG. 7A using a method of transforming variables in a variational data assimilation module using a cubed-sphere grid based on a spectral element method according to an example embodiment of the invention.

Referring to FIG. 7A and FIG. 7B, horizontal wind in a background field in the NWP model may be converted into stream function Psi and a velocity potential Chi based on the above Equation 12. Accordingly, the horizontal wind distribution 610 may be converted into distributions 620 of perturbation stream function and perturbation velocity potential. In the perturbation stream function Psi and perturbation velocity potential Chi distributions, the perturbation stream function is denoted by shading and the perturbation velocity potential is denoted by contour lines. For example, in a North Pacific region which the anticyclonic circulation wind is dominant, the perturbation stream function may be high (i.e., dark shaded). For example, in an East Pacific region above Equator which a divergent wind is dominant, the perturbation velocity potential may be high.

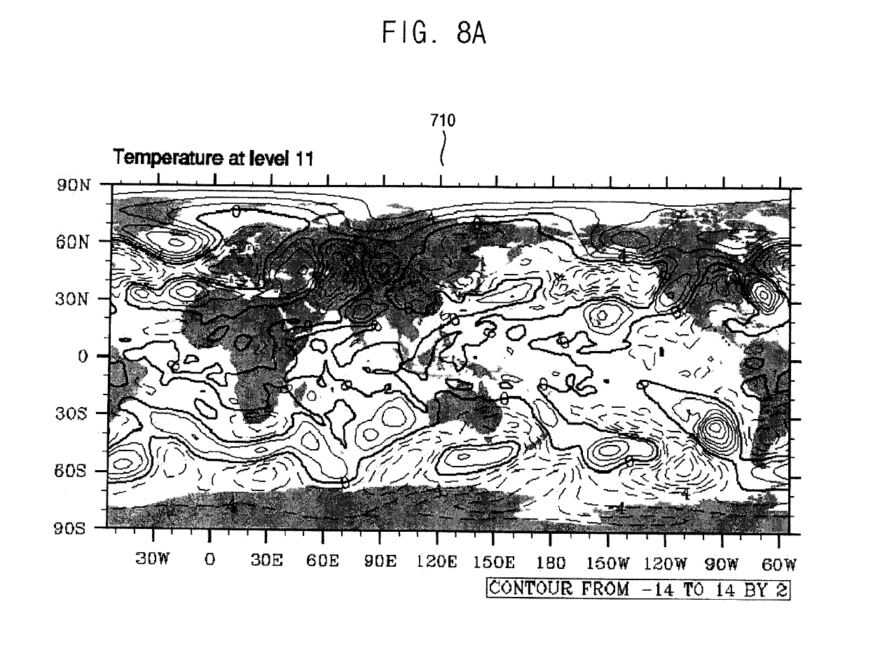

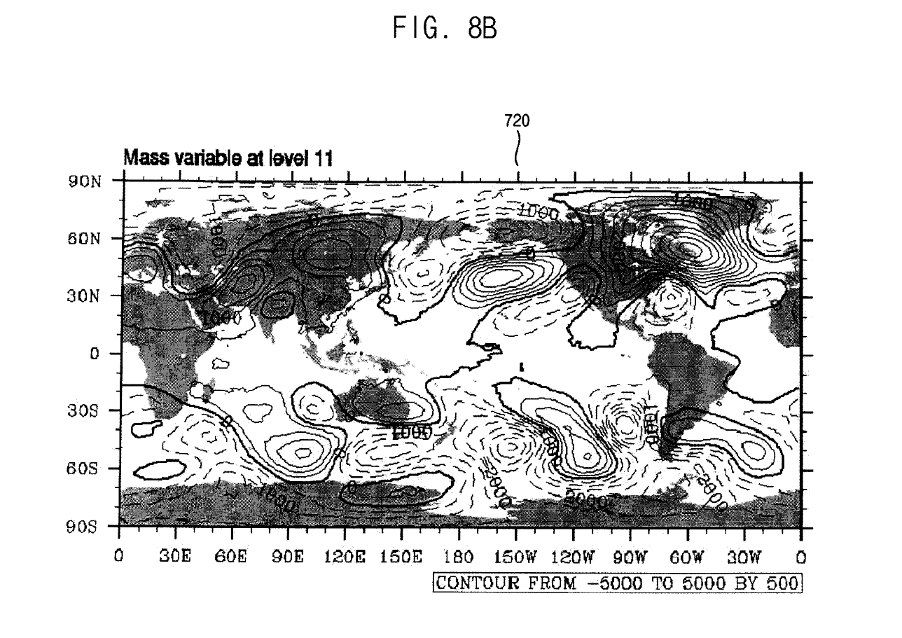

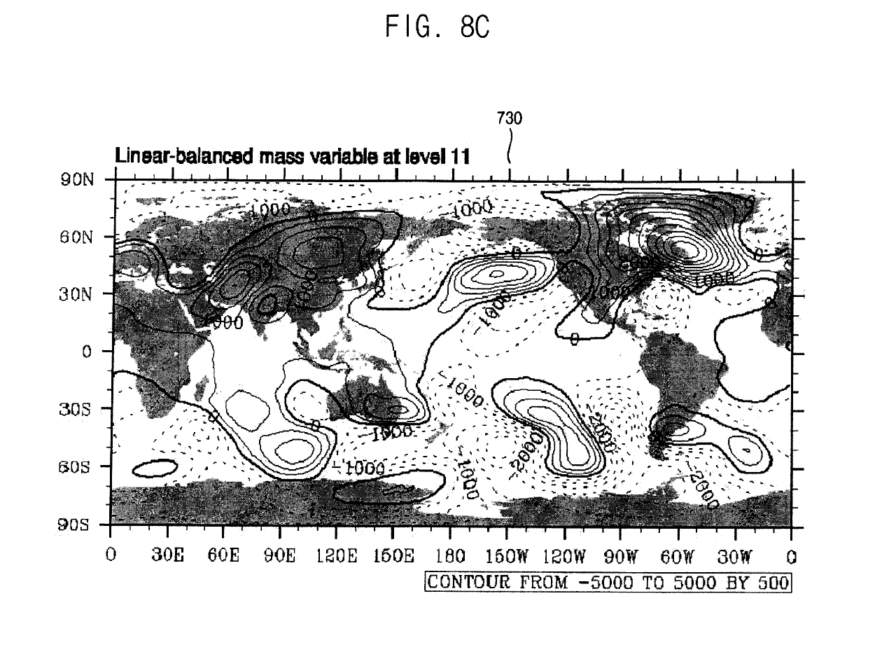

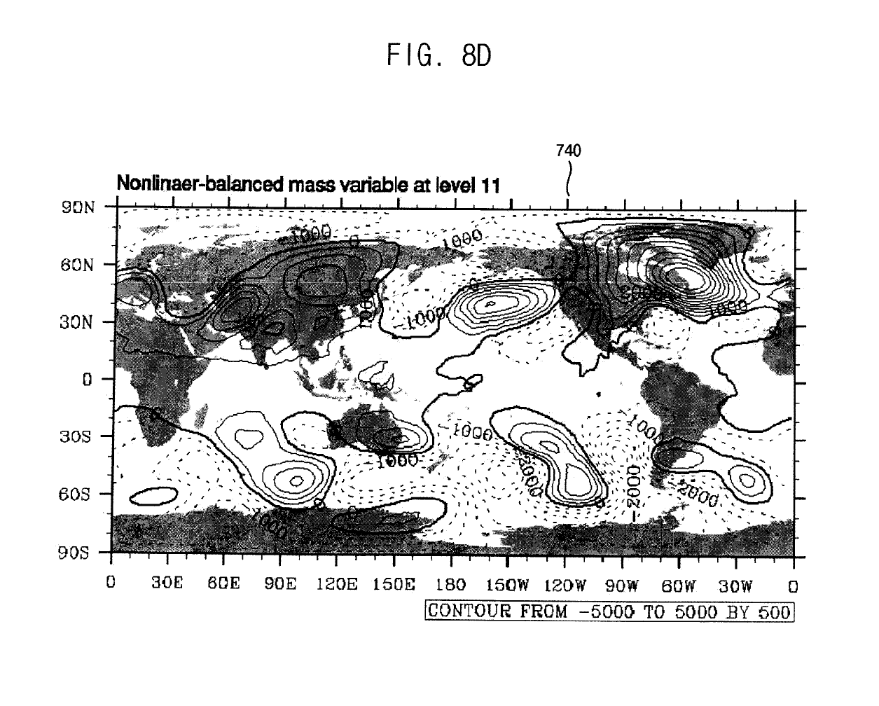

FIG. 8A is a plan view illustrating a perturbation temperature distribution at a predetermined vertical level represented in a longitude-latitude coordinates system, which may be generated in a NWP model using a method of transforming variables in a variational data assimilation module using a cubed-sphere grid based on a spectral element method according to an example embodiment of the invention.

Referring to FIG. 8A, an NWP model using a method of transforming variables in a variational data assimilation module using a cubed-sphere grid based on a SEM according to the present example embodiment may be configured to represent a perturbation temperature distribution 710 at, e.g., a vertical level 11 corresponding to about 140 hPa to about 150 hPa height in a time step. In the perturbation temperature distribution 710, a unit of the perturbation temperature is Celsius degrees.

FIG. 8B is a plan view illustrating a perturbation mass variable distribution at the same vertical level as FIG. 8A represented in the longitude-latitude coordinates system.

Referring to FIG. 8B, the NWP model may be configured to represent a perturbation mass variable distribution 720 at the vertical level 11 in the time step based on the above Equation 14. In the perturbation mass variable distribution 720, a unit of the perturbation mass variable is the same as a unit of geopotential.

FIG. 8C and FIG. 8D are plan views illustrating a perturbation linear balanced mass variable distribution and a perturbation nonlinear balanced mass variable distribution, respectively, represented in the longitude-latitude coordinates system and transformed using a method of transforming variables in a variational data assimilation module using a cubed-sphere grid based on a spectral element method according to an example embodiment of the invention.

Referring to FIG. 8B, FIG. 8C and FIG. 8D, the NWP model may be configured to represent linear balanced mass variable and nonlinear balanced mass variable at the vertical level 11 in the time step. For example, the NWP model may be configured to represent perturbation linear balanced mass variable distribution 730 generated from an equation removing nonlinear terms of the above Equation 20 as illustrated in FIG. 8C. For example, the NWP model may be configured to represent perturbation nonlinear balanced mass variable distribution 740 generated from the above Equation 20 as illustrated in FIG. 8D.

Referring to FIG. 8B and FIG. 8C, the perturbation linear balanced mass variable distribution 730 is well-matched with the perturbation mass variable distribution 720 defined by the above Equation 14.

Referring to FIG. 8B and FIG. 8D, the perturbation nonlinear balanced mass variable distribution 740 is well-matched with the perturbation mass variable distribution 720 defined by the above Equation 14. Also, the perturbation nonlinear balanced mass variable distribution 740 is better-matched with the perturbation mass variable distribution 720 than the perturbation linear balanced mass variable distribution 730 in a region such as, e.g., around 180 degrees in longitude near the Equator.

FIG. 9 is a cross-sectional view illustrating an absolute difference between a first perturbation unbalanced mass using a perturbation nonlinear balanced mass variable and a second perturbation unbalanced mass using a perturbation linear balanced mass variable with respect to a latitude and a vertical level, which may be generated using a method of transforming variables in a variational data assimilation module using a cubed-sphere grid based on a spectral element method according to an example embodiment of the invention.

Referring to FIG. 9, a vertical level 30 denotes a lowermost layer (i.e., surface layer) and a vertical level zero denotes a top of the atmosphere (TOA). A distribution 810 of absolute difference between zonal mean perturbation unbalanced mass variables represents an absolute difference between a first perturbation unbalanced mass variable and a second perturbation unbalanced mass variable. The first perturbation unbalanced mass variable is generated from the Equation 19 to which perturbation nonlinear balanced mass variable in the Equation 20 is substituted. The second perturbation unbalanced mass variable is generated from the Equation 19 to which perturbation linear balanced mass variable in an equation removing nonlinear terms in the Equation 20 is substituted. In the distribution 810 of absolute difference between the zonal mean perturbation unbalanced mass variables, positive values are dominant, which means the first perturbation unbalanced mass variable generated using the perturbation nonlinear balanced mass variable is more accurate than the second perturbation unbalanced mass variable generated using the perturbation linear balanced mass variable. A global average distribution 820 of the absolute difference between perturbation unbalanced mass variables with respect to vertical levels may be obtained by meridionally averaging the distribution 810 of the absolute difference between the zonal mean perturbation unbalanced mass variables. In the global average distribution 820 with respect to the vertical levels, an accuracy of the perturbation unbalanced mass variable is conspicuous at the vertical level 11 based on an addition of the nonlinear terms. The distribution of perturbation balanced mass variables at the vertical level 11 with respect to longitude and latitude is the same as illustrated in FIG. 8C and FIG. 8D.

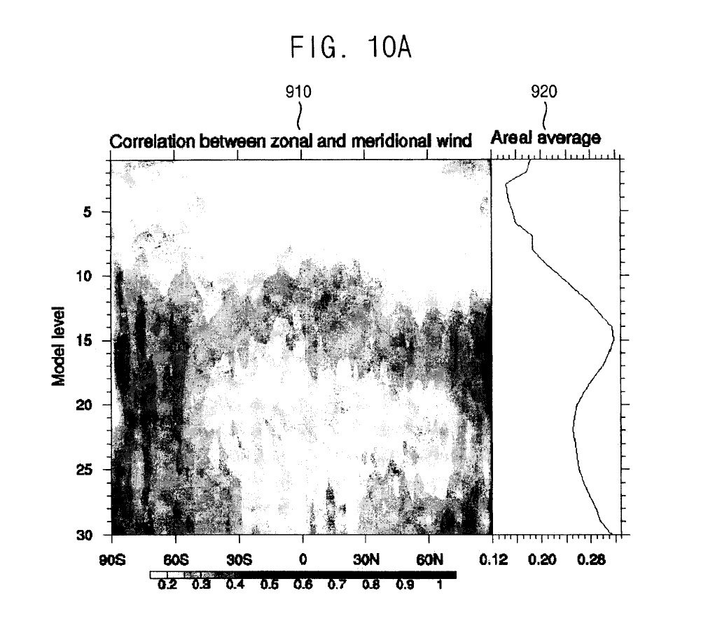

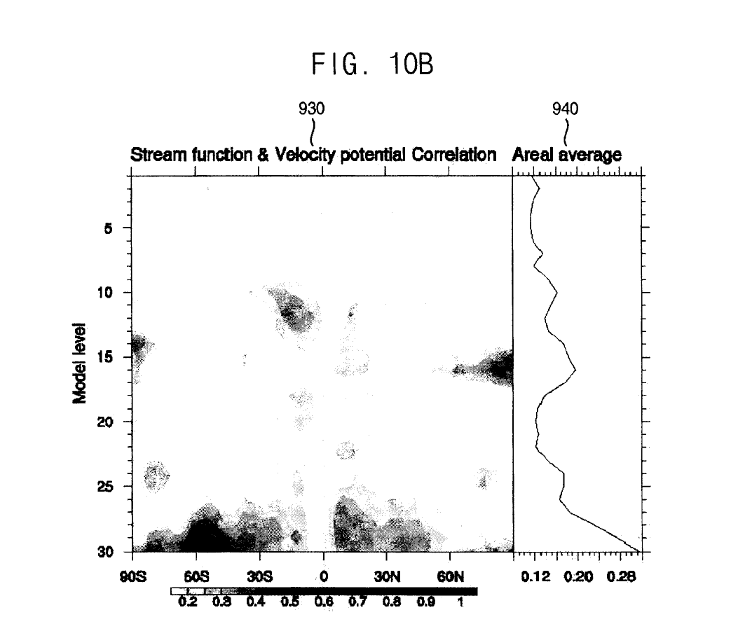

FIG. 10A is a cross-sectional view illustrating an error correlation distribution between a perturbation zonal wind and a perturbation meridional wind with respect to a latitude and a vertical level in an NWP model using a method of transforming variables in a variational data assimilation module using a cubed-sphere grid based on a spectral element method according to an example embodiment of the invention.

Referring to FIG. 10A, an NWP model using a method of transforming variables in a variational data assimilation module using a cubed-sphere grid based on a SEM may be configured to represent a zonal mean error correlation distribution 910 between perturbation zonal wind and perturbation meridional wind. A global average distribution 920 of the error correlation between perturbation zonal wind and perturbation meridional wind with respect to vertical levels may be obtained by meridionally averaging the distribution 910 of zonal mean error correlation between the perturbation zonal wind and perturbation meridional wind. In the zonal mean error correlation distribution 910 and the global average distribution 920, error correlation between the perturbation zonal wind (i.e., u-wind) and the perturbation meridional wind (i.e., v-wind) is greater than about 0.2 at almost vertical levels except a few upper levels (e.g., between vertical level zero and vertical level 10).

FIG. 10B is a cross-sectional view illustrating an error correlation distribution between a perturbation stream function and a perturbation velocity potential with respect to a latitude and a vertical level in an NWP model using a method of transforming variables in a variational data assimilation module using a cubed-sphere grid based on a spectral element method according to an example embodiment of the invention.

Referring to FIG. 10B, an error correlation distribution 930 between zonal mean perturbation stream function and perturbation velocity potential may be represented based on the above Equation 12. The error correlation distribution 930 between zonal mean perturbation stream function and perturbation velocity potential may show a reduced error correlation between the two derivative variables at almost vertical levels compared to the error correlation distribution 910 between the perturbation zonal wind and the perturbation meridional wind in FIG. 10A. A global average distribution 940 of the error correlation between perturbation stream function and perturbation velocity potential with respect to vertical levels may be obtained by meridionally averaging the distribution 930 of zonal mean error correlation between the perturbation stream function and perturbation velocity potential. In the global average distribution 940, error correlation between the perturbation stream function and the perturbation velocity potential is lower than about 0.2 at almost vertical levels except a few lower levels (e.g., between vertical level 27 and vertical level 30).

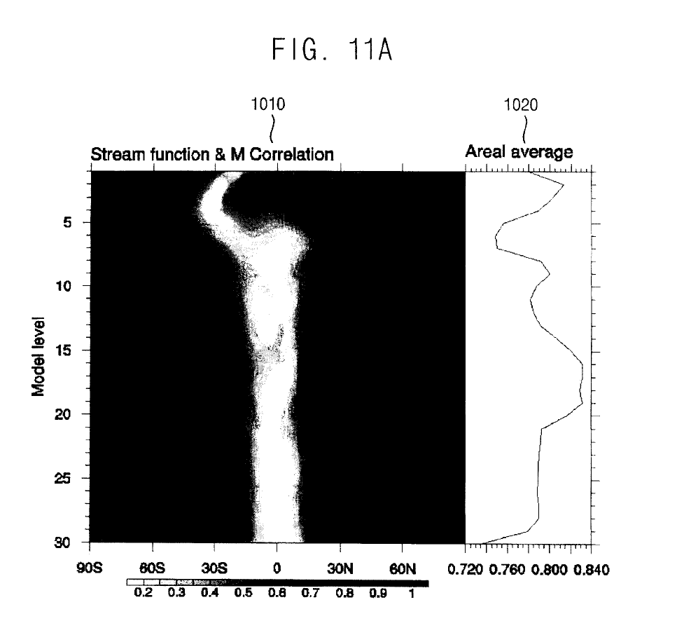

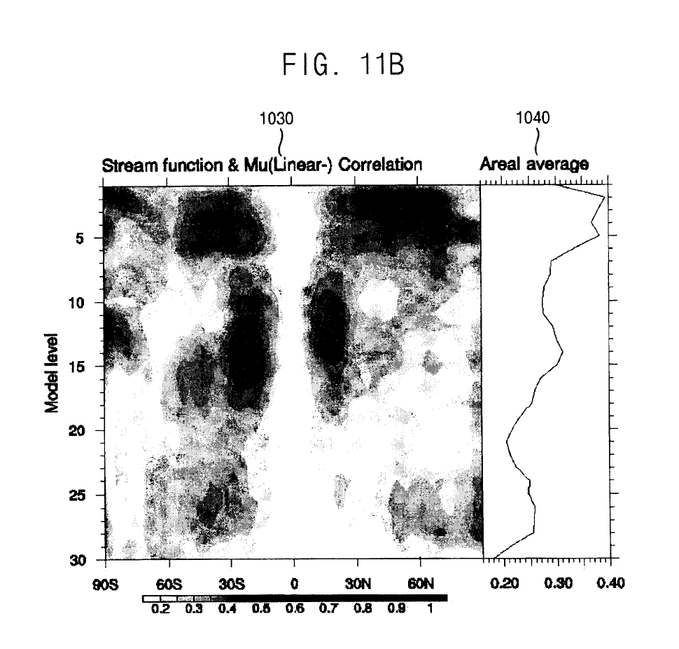

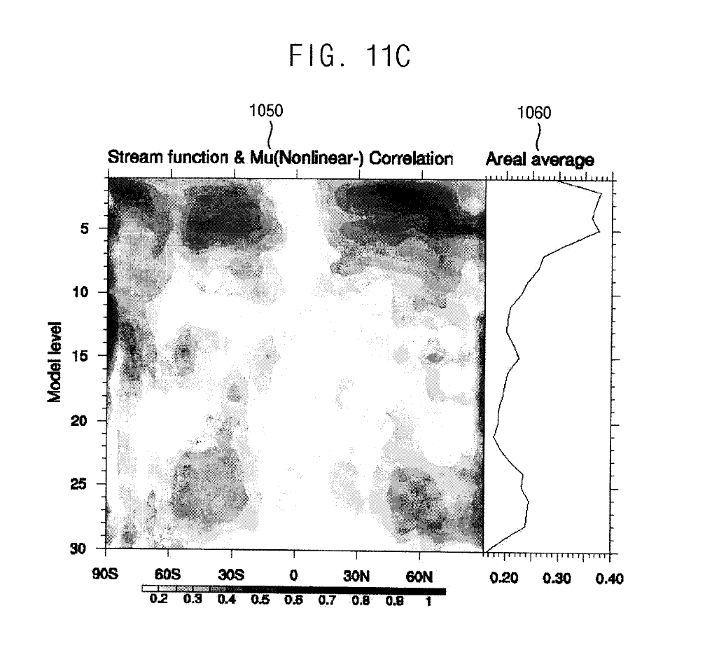

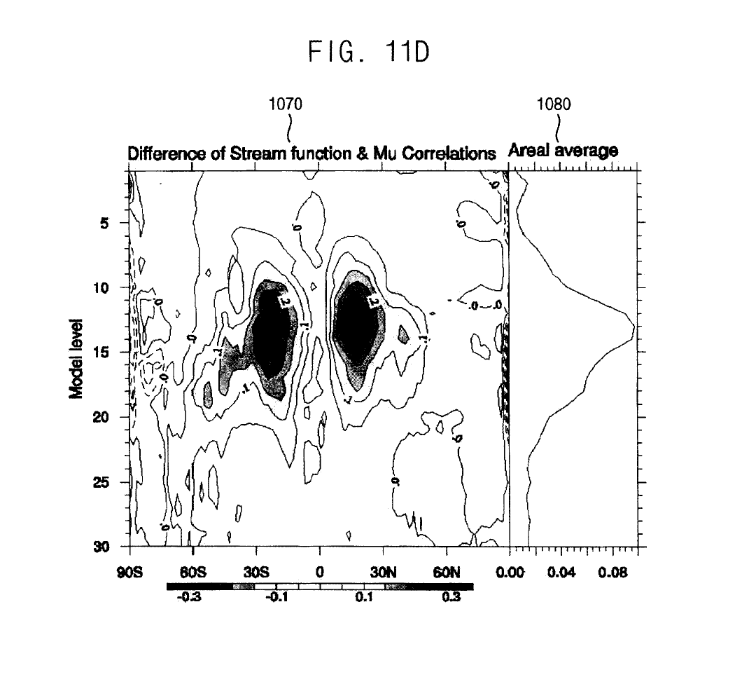

FIG. 11A is a cross-sectional view illustrating an error correlation distribution between a perturbation mass variable and a perturbation stream function with respect to a latitude and a vertical level in an NWP model using a method of transforming variables in a variational data assimilation module using a cubed-sphere grid based on a spectral element method according to an example embodiment of the invention.

Referring to FIG. 11A, an NWP model using a method of transforming variables in a variational data assimilation module using a cubed-sphere grid based on a SEM may be configured to represent a zonal mean error correlation distribution 1010 between a perturbation stream function generated based on the above Equation 12 and a perturbation mass variable defined by the above Equation 14. In the zonal mean error correlation distribution 1010, error correlation between the perturbation stream function and the perturbation mass variable is high in almost mid-latitude and polar region except equator region. A global average distribution 1020 of the error correlation between perturbation stream function and perturbation mass variable with respect to vertical levels may be obtained by meridionally averaging the distribution 1010 of zonal mean error correlation between the perturbation stream function and perturbation mass variable. In the global average distribution 1020, error correlation between the perturbation stream function and the perturbation mass variable is greater than about 0.7 regardless of vertical levels.

FIG. 11B is a cross-sectional view illustrating an error correlation distribution between a perturbation stream function and a perturbation unbalanced mass variable based on a linear mass equation with respect to a latitude and a vertical level in an NWP model using a method of transforming variables in a variational data assimilation module using a cubed-sphere grid based on a spectral element method according to an example embodiment of the invention.

Referring to FIG. 11B, the NWP model may be configured to represent a zonal mean error correlation distribution 1030 between a perturbation stream function generated based on the above Equation 12 and a second perturbation unbalanced mass variable generated by substituting a perturbation linear balanced mass variable from an equation removing nonlinear terms of the Equation 20 into the above Equation 19. A global average distribution 1040 of the error correlation between the second perturbation unbalanced mass variable and the perturbation stream function with respect to vertical levels may be obtained by meridionally averaging the distribution 1030 of zonal mean error correlation between the second perturbation unbalanced mass variable and the perturbation stream function. In the global average distribution 1040, error correlation between the perturbation stream function and the second perturbation unbalanced mass variable is reduced to be lower than about 0.4, which is a significant reduction compared to representation in FIG. 11A.

FIG. 11C is a cross-sectional view illustrating an error correlation distribution between a perturbation stream function and a perturbation unbalanced mass variable based on a nonlinear mass equation with respect to a latitude and a vertical level in an NWP model using a method of transforming variables in a variational data assimilation module using a cubed-sphere grid based on a spectral element method according to an example embodiment of the invention.

Referring to FIG. 11C, the NWP model may be configured to represent a zonal mean error correlation distribution 1050 between the perturbation stream function generated based on the Equation 12 and a first perturbation unbalanaced mass variable generated by substituting a perturbation nonlinear balanced mass variable from the Equation 20 into the above Equation 19. A global average distribution 1060 of the error correlation between the first perturbation unbalanced mass variable and the perturbation stream function with respect to vertical levels may be obtained by meridionally averaging the distribution 1050 of zonal mean error correlation between the first perturbation unbalanced mass variable and the perturbation stream function. In the zonal mean error correlation distribution 1050 and the global average distribution 1060, error correlation between the perturbation stream function and the first perturbation unbalanaced mass variable is reduced to be lower than about 0.4, which is a significant reduction compared to representation in FIG. 11A. Also, the error correlation between the perturbation stream function and the first perturbation unbalanced mass variable is reduced to be lower than about 0.25 except a few upper levels (e.g., between vertical level zero and vertical level 8), which is a better reduction compared to representation in FIG. 11B.

FIG. 11D is a cross-sectional view illustrating a difference between error correlation distributions in FIG. 11B and FIG. 11C.

Referring to FIG. 11D, differences 1070 and 1080 may be obtained by subtracting the error correlation distributions 1030 and 1040 between the perturbation stream function and the second perturbation unbalanced mass variable illustrated in FIG. 11B from the error correlation distributions 1050 and 1060 between the perturbation stream function and the first perturbation unbalanced mass variable illustrated in FIG. 11C. In the differences 1070 and 1080, reduction of the error correlation between the perturbation stream function and the perturbation unbalanced mass variable is conspicuous at mid-levels (e.g., between vertical level 8 and vertical level 18) when nonlinear terms are considered in the above Equation 19 and Equation 20.

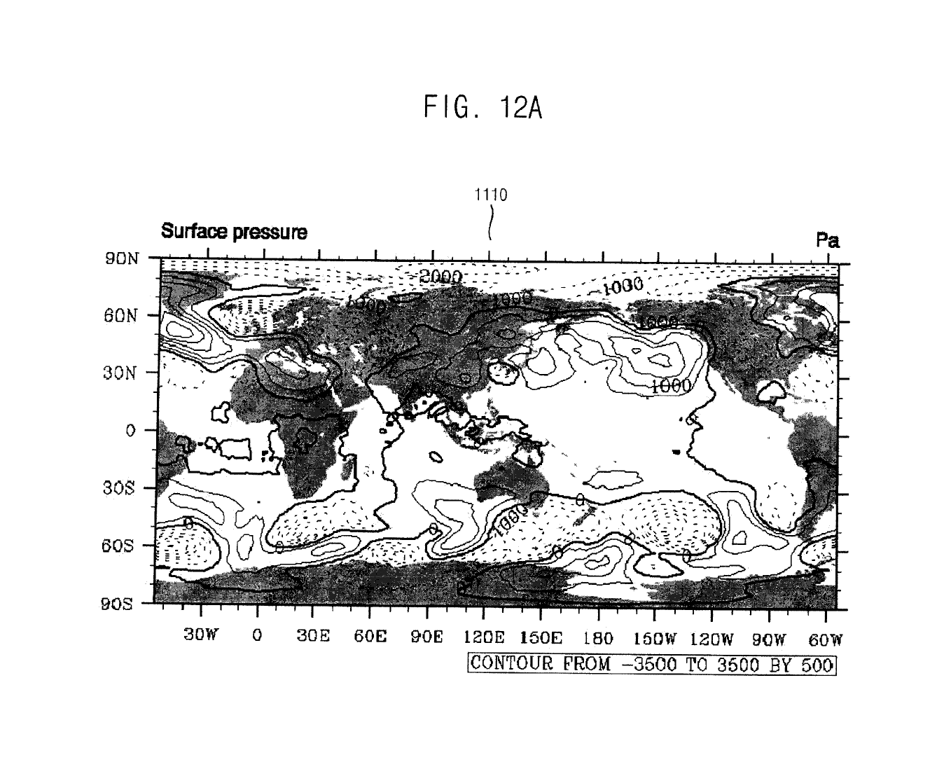

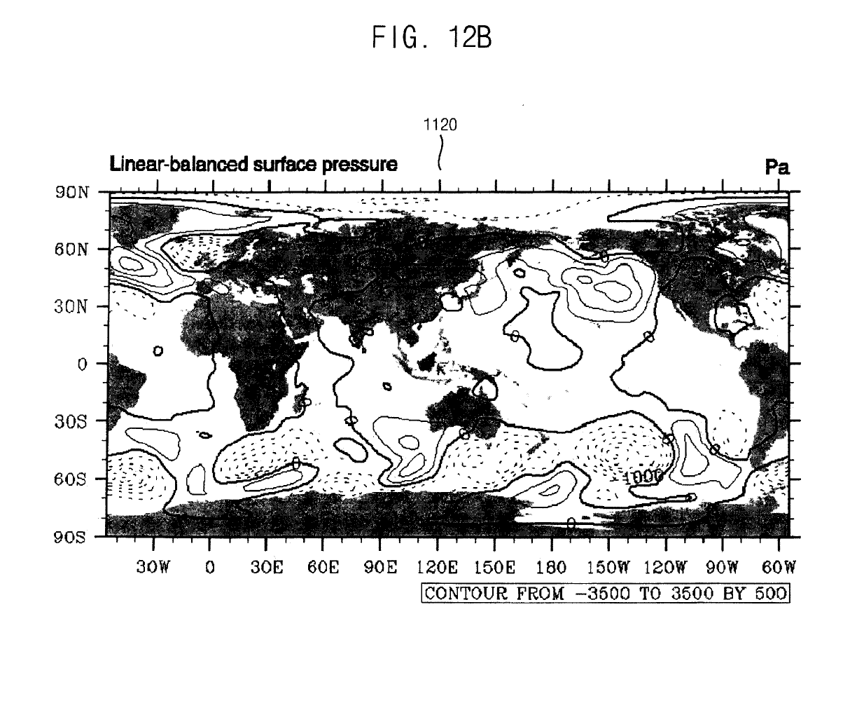

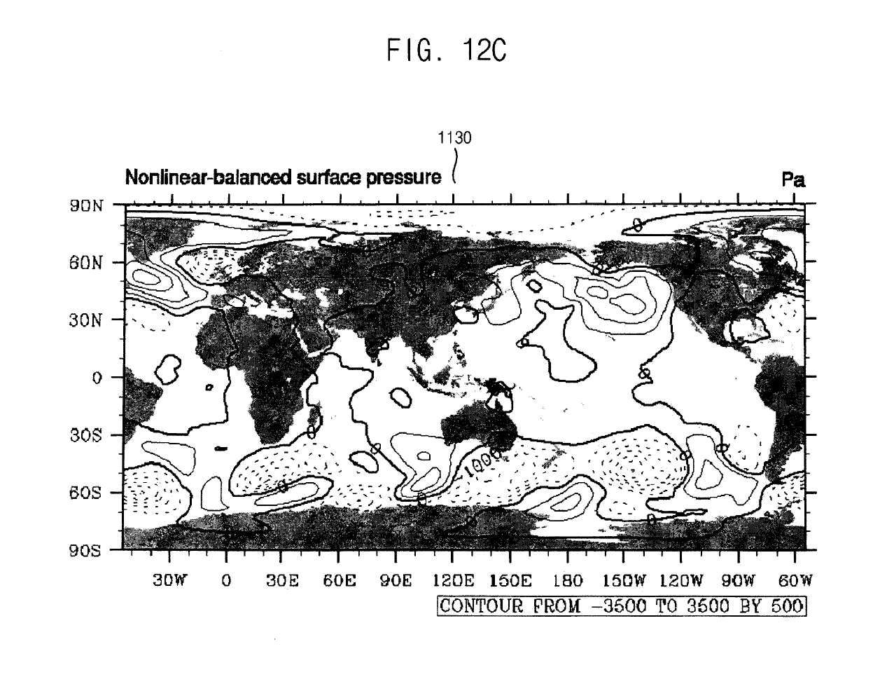

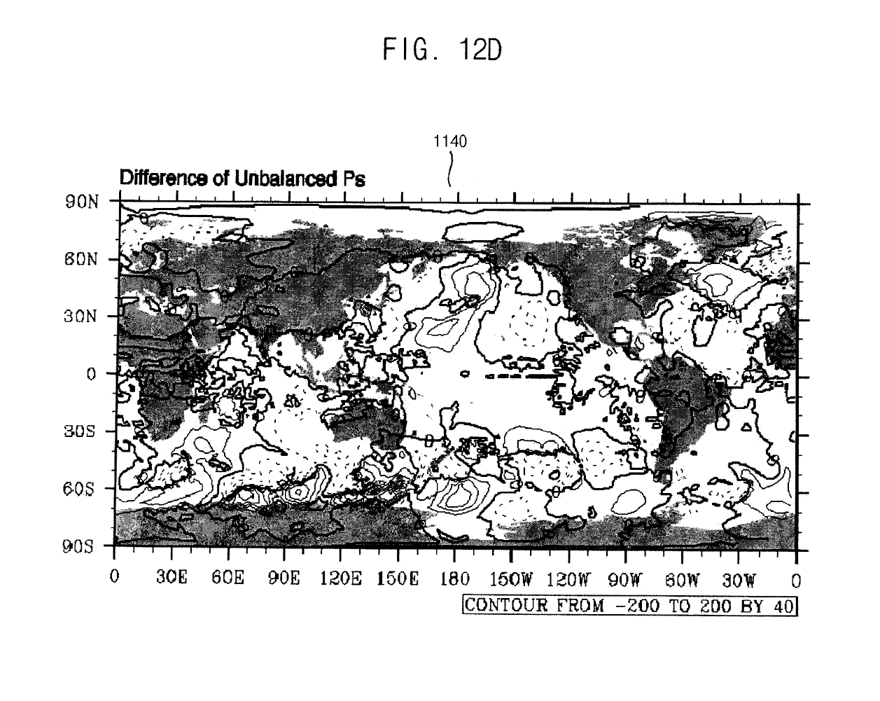

FIG. 12A is a plan view illustrating a perturbation surface pressure distribution represented in a longitude-latitude coordinates system in an NWP model using a method of transforming variables in a variational data assimilation module using a cubed-sphere grid based on a spectral element method according to an example embodiment of the invention.

Referring to FIG. 12A, an NWP model using a method of transforming variables in a variational data assimilation module using a cubed-sphere grid based on a SEM may be configured to represent a perturbation surface pressure distribution 1110. In the perturbation surface pressure distribution 1110, positive deviations may be dominant, e.g., in a North Pacific region.

FIG. 12B is a plan view illustrating a perturbation unbalanced surface pressure distribution based on a linear pressure equation represented in a longitude-latitude coordinates system in an NWP model using a method of transforming variables in a variational data assimilation module using a cubed-sphere grid based on a spectral element method according to an example embodiment of the invention.

Referring to FIG. 12B, the NWP model may be configured to represent a second perturbation unbalanced surface pressure distribution 1120 generated by substituting a perturbation linear surface pressure from an equation removing nonlinear terms in the Equation 23 into the above Equation 22.

FIG. 12C is a plan view illustrating a perturbation unbalanced surface pressure distribution based on a nonlinear pressure equation represented in a longitude-latitude coordinates system in an NWP model using a method of transforming variables in a variational data assimilation module using a cubed-sphere grid based on a spectral element method according to an example embodiment of the invention.

Referring to FIG. 12C, the NWP model may be configured to represent a first perturbation unbalanced surface pressure distribution 1130 generated by substituting a perturbation nonlinear surface pressure from the Equation 23 into the above Equation 22.

FIG. 12D is a plan view illustrating a difference between perturbation unbalanced surface pressure distributions in FIG. 12B and FIG. 12C.

Referring to FIG. 12D, a difference 1140 may be obtained by subtracting the second perturbation linear unbalanced surface pressure distribution 1120 in FIG. 12B from the first perturbation nonlinear unbalanaced surface pressure distribution 1130 in FIG. 12C. In the difference 1140, positive deviations may be dominant around equatorial Pacific region.

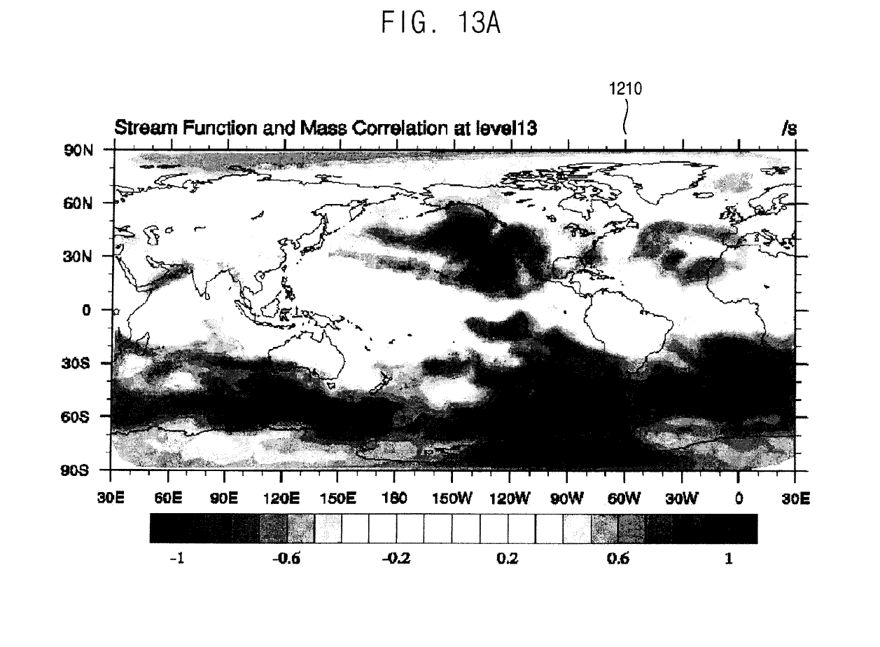

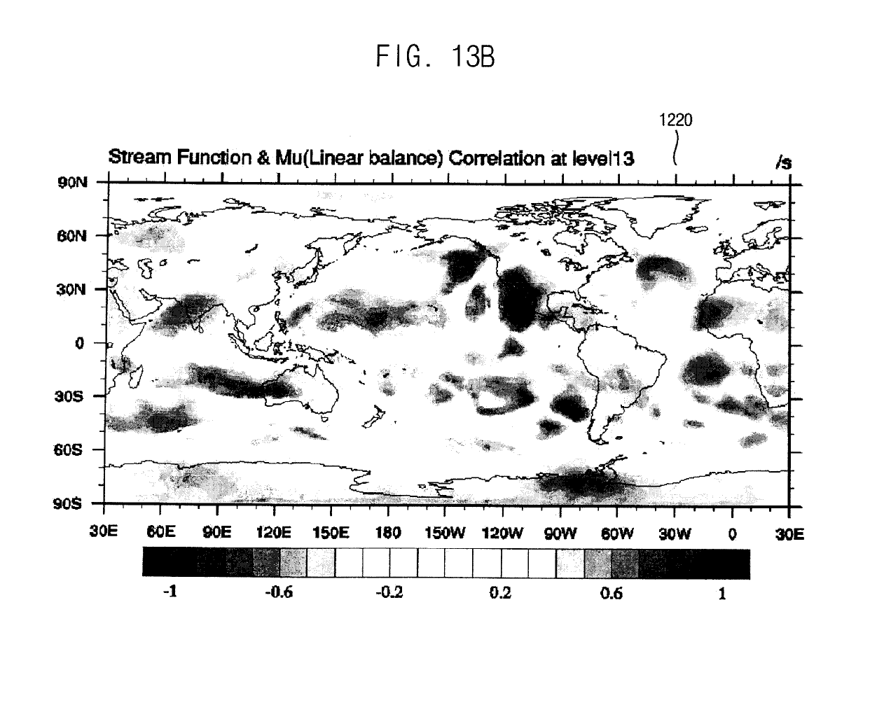

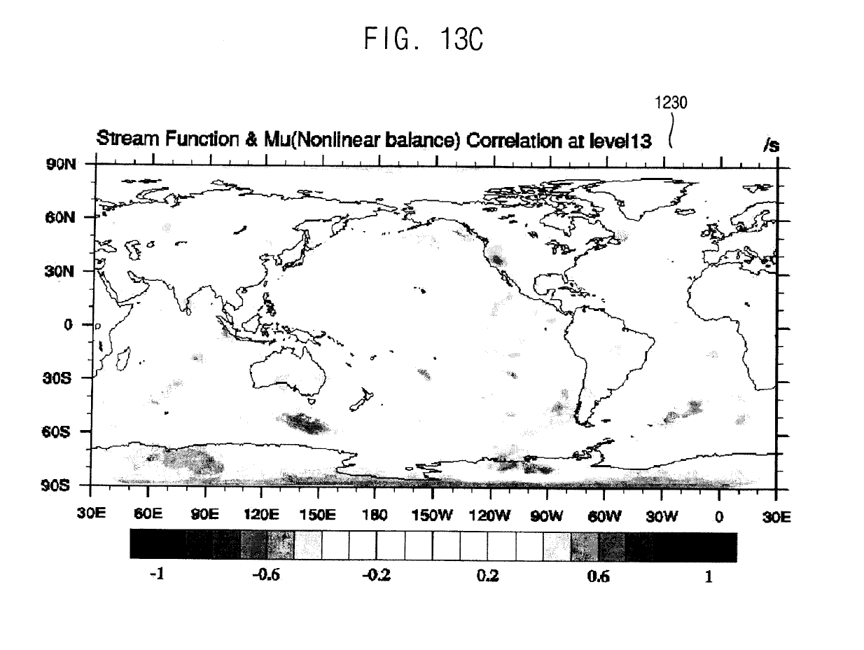

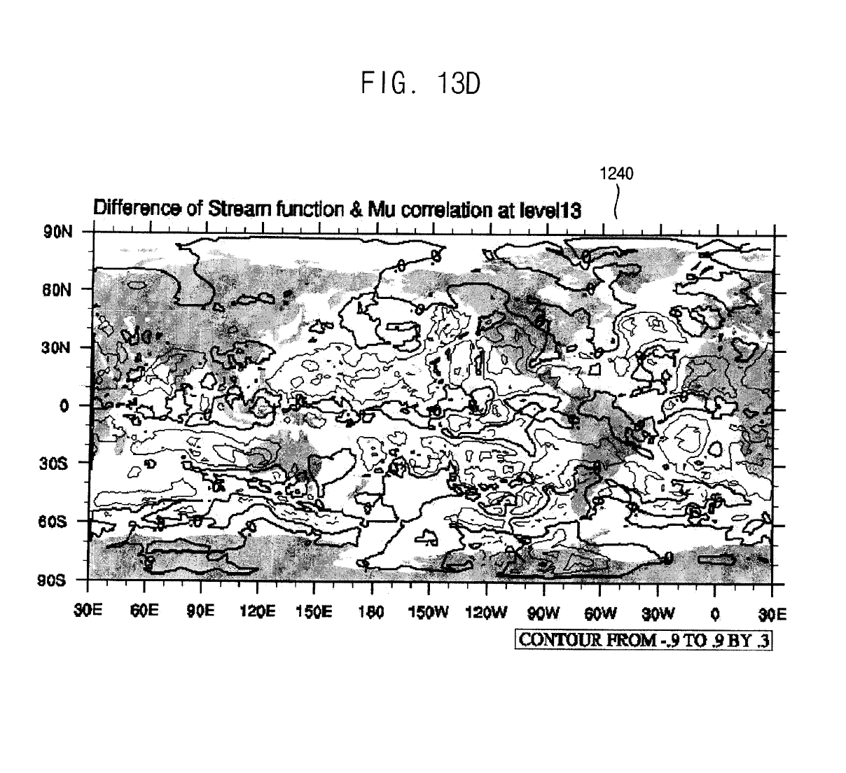

FIG. 13A is a plan view illustrating an error correlation distribution between a perturbation mass variable and a perturbation stream function represented in a longitude-latitude coordinates system in an NWP model using a method of transforming variables in a variational data assimilation module using a cubed-sphere grid based on a spectral element method according to an example embodiment of the invention.

Referring to FIG. 13A, an NWP model using a method of transforming variables in a variational data assimilation module using a cubed-sphere grid based on a SEM may be configured to represent an error correlation distribution 1210 between a perturbation stream function generated based on the above Equation 12 and a perturbation mass variable defined by the above Equation 14 at, e.g., vertical level 13 corresponding to about 200 hPa height.

FIG. 13B is a plan view illustrating an error correlation distribution between a perturbation stream function and a perturbation unbalanced mass variable based on a linear mass equation represented in a longitude-latitude coordinates system in an NWP model using a method of transforming variables in a variational data assimilation module using a cubed-sphere grid based on a spectral element method according to an example embodiment of the invention.

Referring to FIG. 13B, the NWP model may be configured to represent an error correlation distribution 1220 between the perturbation stream function generated from the above Equation 12 and a second perturbation unbalanced mass variable generated by substituting a perturbation linear balanced mass variable from an equation removing nonlinear terms in the Equation 20 into the above Equation 19.

Referring to FIG. 13A and FIG. 13B, the error correlation between the perturbation stream function and the second perturbation unbalanced mass variable is significantly lower than the error correlation between the perturbation stream function and the perturbation mass variable.

FIG. 13C is a plan view illustrating an error correlation distribution between a perturbation stream function and a perturbation unbalanced mass variable based on a nonlinear mass equation represented in a longitude-latitude coordinates system in an NWP model using a method of transforming variables in a variational data assimilation module using a cubed-sphere grid based on a spectral element method according to an example embodiment of the invention.

Referring to FIG. 13C, the NWP model may be configured to represent an error correlation distribution 1230 between the perturbation stream function generated by the above Equation 12 and a first perturbation unbalanced mass variable generated by substituting a perturbation nonlinear balanced mass variable from the Equation 20 into the above Equation 19 at the vertical level 13.

Referring to FIG. 13B and FIG. 13C, the error correlation between the perturbation stream function and the perturbation unbalanced mass variable is globally reduced by considering nonlinear terms in the Equation 20 to generate the perturbation balanced mass variable.

FIG. 13D is a plan view illustrating a difference between error correlation distributions in FIG. 13B and FIG. 13C.

Referring to FIG. 13D, a difference 1240 may be obtained by subtracting the error correlation distribution 1220 between the perturbation stream function and the second perturbation unbalanced mass variable in FIG. 13B from the error correlation distribution 1230 between the perturbation stream function and the first perturbation unbalanaced mass variable in FIG. 13C. In the difference 1240, positive deviations may be dominant globally, which means a better reduction in error correlation between the perturbation stream function and the perturbation unbalanaced mass variable by considering nonlinear terms in the above Equation 20.

As mentioned above, according to one or more example embodiment of the method of transforming variables in a variational data assimilation module using a cubed-sphere grid based on a spectral element method and a hardware device performing the method of the transforming variables in the variational data assimilation module using the cubed-sphere grid based on the spectral element method, derivative weather variables having second error correlations lower than first error correlations between original weather variables may be generated so that error correlations between weather variables represented in a background field may be reduced. The derivative weather variables may be defined in the background field using the cubed-sphere grid based on the spectral element method.

Also, the derivative weather variables may be further transformed by an inverse transformation or a transpose of the inverse transformation so that a more accurate analysis field may be generated by comparing observational field to the background field. Accordingly, an accuracy of weather forecast in an NWP model may be improved.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of the present invention. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

### EXPLANATION ON REFERENCE NUMERALS

| | |
|---|---|
| 100: hardware device | 110: memory |
| 130: computation section | 200: global sphere |
| 210: virtual rectangular surface | |

What is claimed is:

1. A method of transforming variables in a variational data assimilation module using a cubed-sphere grid based on a spectral element method, the method of transforming variables performed in a hardware device comprising a computation section and a memory electrically connected to the computation section, and the method of transforming variables comprising:
converting a perturbation mass variable δM defined by a first equation, by using a perturbation δMbal of a balanced mass variable Mbal generated by a second equation, into a perturbation unbalanced mass variable δMu defined by a third equation,
wherein the first equation is
$$δ M = δ Φ + {RT}_{r} \frac{δ p}{\overline{p}} ,$$
wherein the second equation is
−Σₖ∫_{g}_{ₖ}[D⁻¹D^{-T}∇_{g}Mbalᵢⱼₖ]·[∇_{g}φᵢⱼₖ]\sqrt{g}dαdβ=−Σₖ∫_{Ω}_{ₖ}[D^{T}[−fk×δvᵢⱼₖ+ v̅ᵢ̅ⱼ̅ₖ̅·D^{T}∇_{g}δvᵢⱼₖ+δvᵢⱼₖ·D^{T}·∇_{g} v̅ᵢ̅ⱼ̅ₖ̅]]×[∇_{g}φᵢⱼₖ]dαdβ.
wherein the third equation is
δMᵤ=δM−δM_{bal},
wherein, in the first equation, δΦ is a perturbation geopotential, Tr is a temperature at a reference vertical level, R is a gas constant of an air, p̅ is an average pressure at the reference vertical level, and δp is a perturbation pressure at the reference vertical level,
wherein, in the second equation, Ω is an area of an element according to the spectral element method, scalar k is an index for denoting the element in the spectral element method and is a natural number, vector k is a vertical unit vector, D is a matrix defined by horizontal unit vectors which are covariant in the cubed-sphere grid, Φ is a Lagrange polynomial, subscript ijk denotes a coordinates (i, j) in the element k, \sqrt{g} is a value defined by a fourth equation, a is a first component in the cubed-sphere grid, β is a second component in the cubed-sphere grid, f is a Coriolis parameter, vector V̅ is an average of a wind vector v, vector δv is a perturbation of the wind vector v, and ∇_{g} is a gradient operator in the cubed-sphere grid,
wherein the fourth equation is
\sqrt{g}≡(det(gᵢⱼ))^{1/2}, and
wherein, in the fourth equation, gᵢⱼ is a metric tensor defined in the cubed-sphere grid.

2. The method of claim 1, further comprising:
converting the wind vector v into a stream function Ψ generated by a fifth equation,
wherein the fifth equation is
−Σₖ∫_{Ω}_{ₖ}[D⁻¹D^{-T}∇_{g}Ψᵢⱼₖ]·[∇_{g}φᵢⱼₖ]\sqrt{g}dαdβ=−Σₖ∫_{Ω}_{ₖ}[D^{T}vᵢⱼₖ]×[∇_{g}φᵢⱼₖ]dαdβ.

3. The method of claim 2, further comprising:
inversely converting a perturbation δv_{φ} of a curl wind vector v_{φ} into a horizontal wind vector component generated by a sixth equation,
wherein the sixth equation is
$$δ {v}_{{φ}_{ijk}} = \frac{1}{\sqrt{g}} {∇}_{g} \times {D}^{T} {φ}_{ijk} ,$$
wherein [symbol] is a perturbation stream function at the coordinates (i, j) of the element k.

4. The method of claim 1, further comprising:
converting the wind vector v into a velocity potential χ generated by a seventh equation,
wherein the seventh equation is
−Σₖ∫_{Ω}_{ₖ}[D⁻¹D^{-T}∇_{g}χᵢⱼₖ]·[∇_{g}φᵢⱼₖ]\sqrt{g}dαdβ=−Σₖ∫_{Ω}_{ₖ}[D^{T}vᵢⱼₖ]×[∇_{g}φᵢⱼₖ]dαdβ.

5. The method of claim 4, further comprising:
inversely converting a perturbation δv_{χ} of a divergent wind vector v_{χ} into a horizontal wind vector component generated by an eighth equation,
wherein the eighth equation is
δv_{χ}_{ᵢⱼₖ}= [symbol] D^{T}∇_{g}φᵢⱼₖ,
wherein [symbol] is a perturbation stream function at the coordinates (i, j) of the element k.

6. A hardware device configured to perform a method of transforming variables in a variational data assimilation module using a cubed-sphere grid based on a spectral element method, the hardware device comprising:
a memory configured to store weather data; and
a computation section electrically connected to the memory,
wherein the computation section is configured to convert a perturbation mass variable δM defined by a first equation into a perturbation unbalanced mass variable δMu defined by a third equation by using a perturbation δMbal of a balanced mass variable Mbal generated by a second equation,
wherein the first equation is
$$δ M = δ Φ + {RT}_{r} \frac{δ p}{\overline{p}} ,$$
wherein the second equation is
−Σₖ∫_{Ω}_{ₖ}[D⁻¹D^{-T}∇_{g}Mbalᵢⱼₖ]·[∇_{g}φᵢⱼₖ]\sqrt{g}dαdβ=−Σₖ∫_{Ω}_{ₖ}[D^{T}[−fk×δvᵢⱼₖ+ v̅ᵢ̅ⱼ̅ₖ̅·D^{T}∇_{g}δvᵢⱼₖ+δvᵢⱼₖ·D^{T}·∇_{g} v̅ᵢ̅ⱼ̅ₖ̅]]×[∇_{g}φᵢⱼₖ]dαdβ,
wherein the third equation is
δMᵤ=δM−δM_{bal},
wherein, in the first equation, δΦ is a perturbation geopotential, Tr is a temperature at a reference vertical level, R is a gas constant of an air, p̅ is an average pressure at the reference vertical level, and δp is a perturbation pressure at the reference vertical level,
wherein, in the second equation, Ω is an area of an element according to the spectral element method, scalar k is an index for denoting the element in the spectral element method and is a natural number, vector k is a vertical unit vector, D is a matrix defined by horizontal unit vectors which are covariant in the cubed-sphere grid, Φ is a Lagrange polynomial, subscript ijk denotes a coordinates (i, j) in the element k, \sqrt{g} is a value defined by a fourth equation, α is a first component in the cubed-sphere grid, β is a second component in the cubed-sphere grid, f is a Coriolis parameter, v̅ vector is an average of a wind vector v, vector δv is a perturbation of the wind vector v, and ∇_{g} is a gradient operator in the cubed-sphere grid,
wherein the fourth equation is
\sqrt{g}≡(det(gᵢⱼ))^{1/2}, and
wherein, in the fourth equation, gᵢⱼ is a metric tensor defined in the cubed-sphere grid.

7. The hardware device of claim 6, wherein the computation section is further configured to convert the wind vector v into a stream function Ψ generated by a fifth equation,
wherein the fifth equation is
−Σₖƒ_{Ω}_{ₖ}[D^{-T}D^{-T}∇_{g}φᵢⱼₖ]·[∇_{g}φᵢⱼₖ]\sqrt{g}dαdβ=−Σₖ∫_{Ω}_{ₖ}[D^{T}vᵢⱼₖ]×[∇_{g}φᵢⱼₖ]dαdβ.

8. The hardware device of claim 7, wherein the computation section is further configured to inversely convert a perturbation δv_{Ψ} of a curl wind vector v_{Ψ} into a horizontal wind vector component generated by a sixth equation,
wherein the sixth equation is
$$δ {v}_{{φ}_{ijk}} = \frac{1}{\sqrt{g}} {∇}_{g} \times {D}^{T} {φ}_{ijk} ,$$
and
wherein [symbol] is a perturbation stream function at the coordinates (i, j) of the element k.

9. The hardware device of claim 6, wherein the computation section is further configured to convert the wind vector v into a velocity potential χ generated by a seventh equation,
wherein the seventh equation is
−Σₖƒ_{Ω}_{ₖ}[D⁻¹D^{-T}∇_{g}χᵢⱼₖ]·[∇_{g}φᵢⱼₖ]\sqrt{g}dαdβ=−Σₖ∫_{Ω}_{ₖ}[D⁻¹vᵢⱼₖ]×[∇_{g}φᵢⱼₖ]\sqrt{g}dαdβ

10. The hardware device of claim 9, wherein the computation section is further configured to inversely convert a perturbation δv_{χ} of a divergent wind vector v_{χ} into a horizontal wind vector component generated by an eighth equation,
wherein the eighth equation is
δv_{χ}_{ᵢⱼₖ}= [symbol] D^{T}∇_{g}φᵢⱼₖ,
wherein [symbol] is a perturbation stream function at the coordinates (i, j) of the element k.
